(19) United States
(12) Patent Application Publication
(10) Pub. No.: US 2026/0248163 A1
(43) Pub. Date: Aug. 27, 2026

(54) HIGHLY STABLE WHIPPABLE COMPOSITIONS COMPRISING BETA-CASEIN

(71) Applicant: Rich Products Corporation, Buffalo, NY (US)

(72) Inventors: Pulari Krishnankutty Nair, Hamburg, NY (US); Simon Bissonnette, Niagara Falls (CA); Ralf Reiser, Orchard Park, NY (US)

(21) Appl. No.: 19/163,630

(22) PCT Filed: Mar. 15, 2024
(86) PCT No.: PCT/US2024/020064

§ 371 Date: Sep. 9, 2025

Related U.S. Application Data
(60) Provisional application No. 63/490,439, filed on Mar. 15, 2023.

(51) Int. Cl. A23L 9/20; A23C 11/08; A23L 35/00

(52) U.S. Cl. CPC A23L 9/22; A23C 11/08; A23L 35/10; A23C 2210/206; A23C 2210/30

(57) ABSTRACT

Disclosed herein are food formulations comprising β-casein as the primary casein protein. Also disclosed herein are compositions comprising casein protein enriched in β-casein. Further disclosed herein are whippable or non-whippable emulsion structures comprising β-casein in amounts higher than those typically found in milk and methods of making the compositions.

### CROSS-REFERENCE TO RELATED APPLICATIONS

This application claims priority to U.S. Provisional Patent Application No. 63/490,439, filed Mar. 15, 2023, which is incorporated herein by reference in its entirety.

### FIELD

This disclosure relates to food formulations comprising β-casein as the primary casein protein. Described herein are compositions comprising casein protein enriched in β-casein. Also described herein are whippable and non-whippable emulsions comprising β-casein in amounts higher than those typically found in milk and methods of making the compositions.

### INTRODUCTION

Caseins are proteins found in milk and can be separated from milk to be used in their natural form. Caseins can be further modified by being dissociated into caseinates or partially hydrolyzed into peptides. All three forms are widely used in food applications due to their various techno-functional properties such as solubility, emulsification, foam formation, stabilization, water-binding, gelation, heat stability, and acid stability.

Traditionally sodium caseinate, a derivative of casein where individual caseins exist in soluble or monomeric form, was used as an emulsification agent for many whipped cream and topping applications because of its solubility, emulsification capacity, and emulsion stability. Sodium caseinate consists of soluble caseins with various proportions of αS1 casein, αS2 casein, β-casein, and κ-casein. Caseins have flexible structures with a high proportion of nonpolar groups that are more effective at reducing interfacial tension than rigid proteins with fewer nonpolar groups. β-casein has the highest surface activity followed by monodispersed casein micelles. αS-casein and κ-casein have similar surface activities; however, they have lower surface activity as compared to β-casein and monodispersed casein micelles. It is unknown which of the foregoing caseins contribute to emulsification and stabilization of emulsions.

Thus, there is a need for determining which of the foregoing caseins provides desirable emulsifying properties and stability to food compositions such as high fat emulsions.

### SUMMARY

In one aspect, this disclosure relates to an emulsion composition comprising a fat and a protein, wherein the protein comprises greater than 45 wt. % of β-casein based on the total amount of casein present in the composition. In an embodiment, the composition comprises: from about 5 wt. % to about 45 wt. % of the fat; from about 0.001 wt. % to about 3 wt. % of the protein; from about 0 wt. % to about 55 wt. % of a sweetener; from about 0 wt. % to about 3 wt. % of one or more stabilizers; from about 0.0001 wt. % to about 2 wt. % of buffer salts; and, from about 0 wt. % to about 3 wt. % of one or more emulsifiers. In another embodiment, the composition comprises: from about 5 wt. % to about 35 wt. % of the fat; from about 1 wt. % to about 2.5 wt. % of the protein; from about 5 wt. % to about 45 wt. % of a sweetener; from about 0.5 wt. % to about 3 wt. % of one or more stabilizers; from about 0.5 wt. % to about 2 wt. % of buffer salts; and, from about 0.5 wt. % to about 3 wt. % of one or more emulsifiers. In another embodiment, the fat is a dairy fat, a vegetal fat, vegetal oil, algal oil, fermented oil from bacteria, yeast or mold, hydrogenated oil, hydrogenated and interesterified oil, hydrogenated, blended and interesterified oil, medium-chain triglyceride (MCT) vegetable oil, milk fat, ghee, anhydrous milk fat, butter oil, or a combination thereof. In another embodiment, the protein is an animal protein, a recombinant milk protein, a plant-based protein, or a combination thereof. In another embodiment, the protein is natural casein, recombinant casein, or a combination thereof. In another embodiment, the composition comprises a total κ-casein content of less than 0.03 wt. % based on the total composition. In another embodiment, the protein is enriched in animal and/or recombinant β-casein. In another embodiment, the β-casein is natural or recombinant. In another embodiment, the β-casein is recombinant and comprises an amino acid sequence that is from about 60% to about 100% identical to an amino acid sequence of a mammalian milk protein such as a cow milk protein, a sheep milk protein, a camel milk protein, a yak milk protein, a buffalo milk protein, a horse milk protein, or a goat milk protein. In another embodiment, the proportion of the β-casein is from about 45% to about 100% of the total amount of casein in the composition. In another embodiment, the β-casein is in a micellar form or in a monomeric form; wherein when the β-casein is in a monomeric form, the β-casein has a protein particle size of less than 50 nm. In another embodiment, the β-casein is in a micellar form or in a monomeric form; wherein when the β-casein is in a micellar form, the β-casein has a protein a particle size of less than 500 nm. In another embodiment, the β-casein has a zeta potential of from about −50 mV to about −15 mV in a pH 7.0 buffer. In another embodiment, the protein is in a liquid form or a powder form, wherein the powder form is produced by spray drying, roller drying, drum drying, or freeze drying the protein to remove water. In another embodiment, the protein is a single type of native milk protein, a single type of recombinant milk protein, or a combination thereof. In another embodiment, the single type of protein is β-casein. In another embodiment, the protein is two or more different types of animal milk proteins, recombinant milk proteins, and plant-based proteins. In another embodiment, the protein is with or without post-translational modifications. In another embodiment, the post-translation modifications are one or more of glycosylation and phosphorylation. In another embodiment, the protein is phosphorylated. In another embodiment, the protein comprises non-native phosphorylation. In another embodiment, the recombinant caseins are produced by a fungal cell, a yeast cell, a bacterial cell, algae, or a transgenic method. In another embodiment, the sweetener is a nutritive sweetener, a non-nutritive sweetener, or a combination thereof. In another embodiment, the nutritive sweetener is one or more of sucrose, lactose, glucose, fructose, corn syrup solids, high-fructose corn syrup, dextrose, maltodextrin, brown sugar, honey, and maple syrup, syrups; soluble/insoluble fibers derived from corn, wheat, pea, rice, oat, coconut, barley and/or tapioca; fructo- and galacto-oligosaccharides; and hydrolysed cereal flour; or a combination thereof. In another embodiment, the non-nutritive sweetener is one or more of sucralose, aspartame, saccharin, stevia, monk fruit extract, neotame, advantame, acesulfame potassium, sugar alcohols such as maltitol, xylitol, sorbitol, erythritol, mannitol, isomalt, lactitol, hydrogenated starch hydrolysates, or a combination thereof. In another embodiment, the sweetener is one or more of brazzein, curculin, mabinlin, miraculin, monelin, pentadin, and thaumatin. In another embodiment, the fat comprises one or more lipids derived from a plant, an animal, one or more lipids derived from milk, or a combination thereof. In another embodiment, the fat comprises one or more monoglycerides, diglycerides, triglycerides, and/or phospholipids comprising a short chain fatty acid selected from the group consisting of butyric acid, caproic acid, caprylic acid, and capric acid. In another embodiment, the one or more monoglycerides, diglycerides, triglycerides, and/or phospholipids is a plant-based trans-esterified monoglyceride, diglyceride, triglyceride, and/or phospholipid comprising a short chain fatty acid selected from the group consisting of butyric acid, caproic acid, caprylic acid, and capric acid. In another embodiment, the fat is hydrogenated oil, interesterified oil, hydrogenated and interesterified oil, hydrogenated, blended and interesterified oil, or a combination thereof. In another embodiment, the one or more monoglycerides, diglycerides, triglycerides, and/or phospholipids comprise fatty acyl chains in a percentage that resembles a percentage of the fatty acyl chains found in a mammal-derived milk or dairy product. In another embodiment, the composition is whippable. In another embodiment, the composition is non-whippable. In another embodiment, the composition is a cooking cream or coffee creamer. In another embodiment, the fat is fully hydrogenated, partially hydrogenated, interesterified, non-hydrogenated, or hydrogenated and interesterified. In another embodiment, the fat is fully hydrogenated. In another embodiment, the composition further comprises a crystallizer, a flavoring agent, a salt, a preservative, or a combination thereof. In another embodiment, the protein is one or more of monomeric caseins, sodium caseinate, calcium caseinate, potassium caseinate, acid casein, rennet casein, micellar protein, and globular protein. In another embodiment, the globular protein is one or more of milk derived protein, plant protein, alpha-lactalbumin, beta-lactoglobulin, ovalbumin, ovoglobulin, and recombinant protein. In another embodiment, the micellar protein is micellar casein, a recombinant micellar casein, or a combination thereof. In another embodiment, the plant protein is any cereal, legume, or seed-based protein and present in an amount from about 0.05 wt. % to about 2.5 wt. %. In another embodiment, the micellar casein is sodium caseinate or calcium caseinate and is present in an amount of from about 0.05 wt. % to about 2.5 wt. %. In another embodiment, the stabilizer is one or more of alginate, carrageenan, guar gum, cellulose such as methyl cellulose, microcrystalline cellulose, carboxymethylcellulose, hydroxypropyl methylcellulose (HPMC), sorbitol, xanthan gum, tara gum, locust bean gum, gellan gum (such as high acyl, low acyl), beet pectin, skim milk powder, whole milk powder, partly skimmed milk powder, butter milk powder, dairy products solids, modified starch, agar-agar, gelatin, gum Arabic, konjac, pectin, maltodextrin, and tragacanth. In another embodiment, the emulsifier is one or more of diacetyl tartaric acid esters of mono- and/or diglycerides, lactic acid esters of mono- and/or diglycerides, sodium stearoyl lactylate, lecithin, sorbitan monostearate, polyglycol ester, propylene glycol monostearate, polysorbate, polysorbate 60, polysorbate 80, sucrose esters, sucrose monostearate, monoglyceride, beeswax, camauba wax, candelilla wax, plant waxes, fruit waxes, animal waxes, polyglycerol fatty acid esters, and polyglycerol polyricinoleate (PGPR). In another embodiment, the buffer salt is one or more of any sodium or potassium or calcium salts of citrate, phosphate, carbonate such as sodium polyphosphates, orthophosphate, pyrophosphate, hexametaphosphate, mono- or di-phosphate salts, mono- or di-carbonates, and halide salt.

In another aspect, this disclosure relates to a food product comprising any of the compositions disclosed herein. In an embodiment, the food product is a dairy product, a non-animal-derived product, a beverage product, or a combination thereof. In another embodiment, the food product is a coffee creamer, a cooking cream, a whipping cream, or a similar low to high fat emulsion. In another embodiment, the food product comprises from about 0.001 wt. % to about 3 wt. % of the protein.

In another aspect, this disclosure relates to a method of making the composition of any one of clauses 1-46, the method comprising: forming an oil phase comprising the fat; forming an aqueous phase comprising the protein; adjusting the oil phase and aqueous phase from about 15° C. to about 75° C.; mixing the oil phase and the aqueous phase to form a mixture; homogenizing the mixture to form an emulsion; heating the emulsion to about 50° C. to about 145° C.; and cooling the emulsion to about 2° C. to about 30° C. In an embodiment, the method further comprises packing the emulsion in sterile or non-sterile conditions. In another embodiment, the method further comprises storing the emulsion at from about −18° C. to about −15° C., from about 3° C. to about 5° C., or from about 18° C. to about 25° C. In another embodiment, the aqueous phase further comprises stabilizers, emulsifiers, and buffering salts. In another embodiment, the method further comprises aerating the emulsion or quiescently storing the emulsion. In another embodiment, aerating comprises whisking, mixing using a planetary mixer, or whipping using a continuous whipping machine. In another embodiment, the method further comprises heat treating, pasteurizing, or sterilizing the emulsion. In another embodiment, the heat treating, pasteurizing, or sterilizing comprises retort, high hydrostatic pressure, ultra-violet radiation, irradiation, or ultra-high temperature processing. In another embodiment, the emulsion has an improved storage stability compared to a corresponding emulsion.

In another aspect, this disclosure relates to a method of preparing a whipped emulsion, the method may comprise whipping any of the emulsions described herein, wherein the whipping may be performed at from about 2° C. to about 8° C.

This disclosure provides for other aspects and embodiments that will be apparent in light of the following detailed description and accompanying figures.

### BRIEF DESCRIPTION OF THE DRAWINGS

FIG. 1 is a graph showing a capillary electrophoresis elution profile for a beta-casein extract.

FIG. 2 is an RP-HPLC chromatogram of neutralized beta-casein extract showing high purity of beta-casein compared to other milk proteins.

FIG. 3 is a graph showing particle size density (PSD) data for protein particles in solution measured by Zetasizer DLS technique.

FIG. 4 is a graph showing surface tension measurements of air-water interface made with an Automatic Drop Tensiometer in rising drop configuration after 25 minutes of equilibration time.

FIG. 5 is a graph showing foam height decay over time of 0.25% protein solutions as measured by Dynamic Foam Analyzer.

FIG. 6 is images of a whipped sodium caseinate composition and a whipped beta-casein composition.

FIG. 7 is a graph showing the effect of increasing the proportion of beta-casein in protein blends with sodium caseinate on particle size in simple emulsions (20% canola oil).

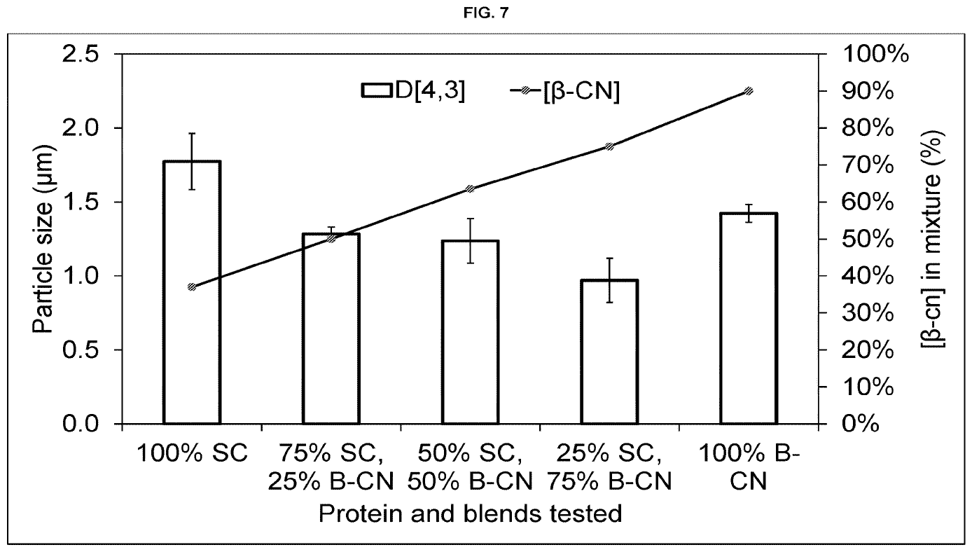

FIG. 8 is images showing the initial (t=0) rosettes from whipped samples E, F, G, H, I, and J.

FIG. 9 is images showing the stability bowls from whipped samples E, F, G, H, I, and J after 24 hours in refrigeration (i.e., from about 2° C. to about 4° C.).

### DETAILED DESCRIPTION

Due to its amphiphilic structure, β-casein has emulsifying and foam stabilizing properties. Described herein is a β-casein-enriched protein solution. The experiments herein characterize the functionality of β-casein in emulsions for creamers, toppings, and high fat toppings. Additionally, demonstrated herein is that enrichment of protein solutions with β-casein leads to overall protein content reduction and cost savings. Finally, in addition to bovine-derived casein proteins, non-bovine derived casein proteins from recombinant sources can also be used to improve emulsion properties.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9; for the range from 6 to 9, the numbers 7 and 8 are contemplated in addition to 6 and 9; and for the range 6.0-7.0, the number 6.0, 6.1, 6.2, 6.3, 6.4, 6.5, 6.6, 6.7, 6.8, 6.9, and 7.0 are explicitly contemplated.

The term “about” or “approximately” as used herein as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In certain aspects, the term “about” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “about” can mean within 3 or more than 3 standard deviations, per the practice in the art. Alternatively, such as with respect to biological systems or processes, the term “about” can mean within an order of magnitude, preferably within 5-fold, and more preferably within 2-fold, of a value.

The term “casein monomer” as used herein refers to a polypeptide that comprises a sequence of at least 20 amino acids (e.g., at least 20, at least 30, at least 40, at least 50, at least 60, at least 70, at least 80, at least 90, at least 100, or at least 150, and usually not more than 250 amino acids) that is at least 80% identical (e.g., at least 85%, at least 90%, at least 95% identical, at least 99% identical) to a sequence of amino acids in a casein and that is repeated in a polymer provided herein. For example, the casein monomer may comprise a polypeptide comprising a sequence of about 20 amino acids to about 220 amino acids; about 40 amino acids to about 200 amino acids; about 60 amino acids to about 180 amino acids; about 80 amino acids to about 160 amino acids; or about 100 amino acids to about 140 amino acids. For example, the casein monomer may not exceed 220 amino acids. Non-limiting examples of caseins include β-casein, γ-casein, κ-casein, αS1-casein, and αS2-casein.

“Cheese” as used herein refers to a group of fermented milk-based products that involve one of the typical examples of food preservation such as gelation of casein via iso-electric (acid) or enzymatic (rennet) coagulation. A few cheeses are produced by a combination of heat and acid and still fewer by thermal evaporation and reduction of water activity through removal of water and with or without the addition of NaCl. Cheeses produced by acid or heat/acid coagulation are usually consumed fresh, while rennet cheeses are almost always ripened before consumption through the action of a complex battery of enzymes.

“Cheese products” as used herein refers to pasteurized process cheese products (PCPs) that are cheese-based foods produced by comminuting, blending, and melting one or more natural cheeses and optional ingredients into a smooth homogeneous blend with the aid of heat, mechanical shear, and (usually) emulsifying salts(ES).

The term “host cell” or “recombinant host cell” as used herein refers to a cell comprising a recombinant polynucleotide that has been introduced. It should be understood that such terms are intended to refer not only to the particular subject cell but also to the progeny of such a cell. Because certain modifications may occur in succeeding generations due to either mutation or environmental influences, such progeny may not be identical to the parent cell but are still included within the scope of the term “host cell” or “recombinant host cell” as used herein.

The term “identical” as used herein in the context of polynucleotide or polypeptide sequences refers to the residues in the two sequences that are the same when aligned for maximum correspondence. There are a number of different algorithms known in the art that can be used to measure polynucleotide or polypeptide sequence identity. For instance, sequences can be compared using FASTA (e.g., using its default parameters as provided in the Wisconsin Package Version 10.0, Genetics Computer Group (GCG), Madison, Wis.), Gap (e.g., using its default parameters as provided in the Wisconsin Package Version 10.0, GCG, Madison, Wis.), Bestfit, ClustalW (e.g., using default paramaters of Version 1.83), or BLAST (e.g., using reciprocal BLAST, PSI-BLAST, BLASTP, BLASTN) (see, for example, Pearson. 1990. Methods Enzymol. 183:63; Altschul et al. 1990. J. Mol. Biol. 215:403).

“Native” or “natural” as used herein, refers to an ingredient derived from an animal or plant that is not synthesized from other forms of the ingredient or is not recombinant. “Native casein” or “natural casein” as used herein, refers to a casein derived from bovine or mammalian milk that is not synthesized from other forms of casein or is not recombinant.

The term “post-translational modification”, or its acronym “PTM”, as used herein refers to the covalent attachment of a chemical group to a protein after protein biosynthesis. PTM can occur on the amino acid side chain of the protein or at its C- or N-termini. Non-limiting examples of PTMs include glycosylation (i.e., covalent attachment to proteins of glycan groups (i.e., monosaccharides, disaccharides, polysaccharides, linear glycans, branched glycans, glycans with galf residues, glycans with sulfate and/or phosphate residues, D-glucose, D-galactose, D-mannose, L-fucose, N-acetyl-D-galactose amine, N-acetyl-D-glucose amine, N-acetyl-D-neuraminic acid, galactofuranose, phosphodiesters, N-acetylglucosamine, N-acetylgalactosamine, sialic acid, and combinations thereof; see, for example, Deshpande et al. 2008. Glycobiology 18 (8): 626) via C-linkage, N-linkage, or O-linkage, or via glypiation (i.e., addition of a glycosylphosphatidylinositol anchor) or phosphoglycosylation (i.e., linked through the phosphate of a phospho-serine), phosphorylation (i.e., covalent attachment to proteins of phosphate groups), alkylation (i.e., covalent attachment to proteins of alkane groups (e.g, methane group in methylation), and lipidation (i.e., covalent attachment of a lipid group (e.g., isoprenoid group in prenylation and isoprenylation (e.g., farnesol group in farnesylation, geraniol group in geranylation, geranylgeraniol group in geranylgeranylation), fatty acid group in fatty acylation (e.g., myristic acid in myristoylation, palmitic acid in palmitoylation), glycosylphosphatidylinositol anchor in glypiation), hydroxylation (i.e., covalent attachment of a hydroxide group), sumoylation (i.e., attachment to proteins of Small Ubiquitin-like Modifier (or SUMO) protein), nitrosylation (i.e., attachment to proteins of an NO group), and tyrosine nitration (i.e., attachment to tyrosine residues of proteins of nitrate groups).

The term “recombinant protein” or “recombinant β-casein” as used herein refers to a protein or β-casein, respectively, that is produced recombinantly (i.e., that is produced by a recombinant host cell). The expression of the protein in the host cell may be transient expression or stable expression.

The term “recombinant polynucleotide” as used herein refers to a polynucleotide that has been removed from its naturally occurring environment, a polynucleotide that is not associated with all or a portion of a polynucleotide abutting or proximal to the polynucleotide when it is found in nature, a polynucleotide that is operatively linked to a polynucleotide that it is not linked to in nature, or a polynucleotide that does not occur in nature. The term can be used, e.g., to describe cloned DNA isolates, or a polynucleotide comprising a chemically synthesized nucleotide analog. A polynucleotide is also considered “recombinant” if it contains any genetic modification that does not naturally occur. For instance, an endogenous polynucleotide is considered a “recombinant polynucleotide” if it contains an insertion, deletion, or substitution of one or more nucleotides that is introduced artificially, e.g., by human intervention. Such modification can introduce into the polynucleotide a point mutation, substitution mutation, deletion mutation, insertion mutation, missense mutation, frameshift mutation, duplication mutation, amplification mutation, translocation mutation, or inversion mutation. The term includes a polynucleotide in a host cell's chromosome, as well as a polynucleotide that is not in a host cell's chromosome (e.g., a polynucleotide that is comprised in an episome).

As used herein, “sweetener” refers to an ingredient and/or a mixture of ingredients that imparts sweetness to a final product.

“Yogurt” as used herein refers to the food produced by culturing one or more optional dairy ingredients with a characterizing bacterial culture that contains the lactic acid-producing bacteria, such as Lactobacillus delbrueckii subsp. bulgaricus and Streptococcus thermophilus to a pH of 4.6 or lower.

“Yogurt products” as used herein refers to products where yogurt is used as an ingredient such as yogurt with fruit inclusions, smoothies, cultured drinks, and the like.

Unless otherwise defined herein, scientific and technical terms used in connection with the present disclosure shall have the meanings that are commonly understood by those of ordinary skill in the art. For example, any nomenclatures used in connection with, and techniques of, food science, microbiology, biochemistry, and chemistry described herein are those that are well known and commonly used in the art. The meaning and scope of the terms should be clear; in the event however of any latent ambiguity, definitions provided herein take precedent over any dictionary or extrinsic definition. Further, unless otherwise required by context, singular terms shall include pluralities and plural terms shall include the singular.

### 2. Composition

Provided herein are compositions for emulsifying and stabilizing whippable and non-whippable food products. In some embodiments, the composition may comprise a protein, such as β-casein, and a fat. The total protein content may range from about 0.05 wt. % to about 3 wt. %, about 0.10 wt. % to about 3 wt. %, about 0.15 wt. % to about 3 wt. %, about 0.25 wt. % to about 3 wt. %, about 0.50 wt. % to about 3 wt. %, about 1 wt. % to about 3 wt. %, about 1.5 wt. % to about 3 wt. %, about 2 wt. % to about 3 wt. %, about 2.5 wt. % to about 3 wt. %, about 0.05 wt. % to about 2.5 wt. %, about 0.05 wt. % to about 2 wt. %, about 0.05 wt. % to about 1.5 wt. %, about 0.05 wt. % to about 1 wt. %, about 0.05 wt. % to about 0.50 wt. %, about 0.05 wt. % to about 0.25 wt. %, about 0.05 wt. % to about 0.15 wt. %, or about 0.05 wt. % to about 0.10 wt. % of the composition. In some embodiments, the total protein content may range from about 0.05 wt. % to about 3 wt. % of the composition. The protein may comprise from about 0.01 wt. % to about 100 wt. % of casein based on the total amount of protein present in the composition. The protein may comprise from about 0.01 wt. % to about 100 wt. %, about 0.5 wt. % to about 100 wt. %, about 1 wt. % to about 100 wt. %, about 10 wt. % to about 100 wt. %, about 20 wt. % to about 100 wt. %, about 30 wt. % to about 100 wt. %, about 40 wt. % to about 100 wt. %, about 50 wt. % to about 100 wt. %, about 60 wt. % to about 100 wt. %, about 70 wt. % to about 100 wt. %, about 80 wt. % to about 100 wt. %, about 90 wt. % to about 100 wt. %, about 0.01 wt. % to about 90 wt. %, about 0.01 wt. % to about 80 wt. %, about 0.01 wt. % to about 70 wt. %, about 0.01 wt. % to about 60 wt. %, about 0.01 wt. % to about 50 wt. %, about 0.01 wt. % to about 40 wt. %, about 0.01 wt. % to about 30 wt. %, about 0.01 wt. % to about 20 wt. %, about 0.01 wt. % to about 10 wt. %, about 0.01 wt. % to about 1 wt. %, or about 0.5 wt. % to about 100 wt. % of casein based on the total amount of protein present in the composition. The protein may comprise from about 45 wt. % to about 100 wt % of β-casein based on the total amount of casein present in the composition. The protein may comprise from about 45 wt. % to about 100 wt. %, about 50 wt. % to about 100 wt. %, about 55 wt. % to about 100 wt. %, about 60 wt. % to about 100 wt. %, about 65 wt. % to about 100 wt. %, about 70 wt. % to about 100 wt. %, about 75 wt. % to about 100 wt. %, about 80 wt. % to about 100 wt. %, about 85 wt. % to about 100 wt. %, about 90 wt. % to about 100 wt. %, about 95 wt. % to about 100 wt. %, about 45 wt. % to about 95 wt. %, about 45 wt. % to about 90 wt. %, about 45 wt. % to about 85 wt. %, about 45 wt. % to about 80 wt. %, about 45 wt. % to about 75 wt. %, about 45 wt. % to about 70 wt. %, about 45 wt. % to about 65 wt. %, about 45 wt. % to about 60 wt. %, about 45 wt. % to about 55 wt. %, or about 45 wt. % to about 50 wt. %, of β-casein based on the total amount of casein present in the composition. The protein may comprise equal to or greater than 45 wt. %, greater than 50 wt. %, greater than 55 wt. %, greater than 60 wt. %, greater than 65 wt. %, greater than 70 wt. %, greater than 75 wt. %, or greater than 80 wt. % of β-casein based on the total amount of casein present in the composition. The composition may further comprise sweeteners, stabilizers, buffer salts, bulking agents, and emulsifiers.

a. Protein

The composition may comprise from about 0.001 wt. % to about 3 wt. %, about 0.01 wt. % to about 3 wt. %, about 0.1 wt. % to about 3 wt. %, about 1 wt. % to about 3 wt. %, about 2 wt. % to about 3 wt. %, about 0.001 wt. % to about 2 wt. %, about 0.001 wt. % to about 1 wt. %, about 0.001 wt. % to about 0.1 wt. %, or about 0.001 wt. % to about 0.01 wt. % of a protein. In some embodiments, the composition may comprise from about 0.001 wt. % to about 3 wt. % of a protein. In some embodiments, the composition may comprise from about 1 wt. % to about 2 wt. % of the protein. The protein may be in a liquid form or a powder form. The powder form may be produced by spray drying, roller drying, drum drying, or freeze drying the protein to remove water. The protein may be devoid of one or more post-translational modifications. For example, the protein may be devoid of one or more of the following post-translation modifications: glycosylation, phosphorylation, or a combination thereof. The protein may be phosphorylated. The protein may comprise non-native phosphorylation. The protein may be one or more of monomeric caseins, sodium caseinate, calcium caseinate, micellar protein, and globular protein. The globular protein may be one or more of milk derived protein, plant protein, beta-lactoglobulin, ovalbumin, alpha lactalbumin, ovoglobulin, bacterial, mycotic, and recombinant protein. The micellar protein may be micellar casein or a recombinant micellar casein. The casein may exist in micellar form or aggregated or monomeric form. The monomeric casein may be sodium caseinate or potassium caseinate. The aggregated casein may be calcium caseinate. The micellar casein may be micellar casein concentrate/isolate, milk protein concentrate/isolate, skim milk powder, whole milk powder, partly skimmed milk powder, or butter milk powder. The caseins may be present in the composition in an amount of from about 0.05 wt. % to about 2.5 wt. %, about 0.1 wt. % to about 2.5 wt. %, about 0.5 wt. % to about 2.5 wt. %, about 1.0 wt. % to about 2.5 wt. %, about 1.5 wt. % to about 2.5 wt. %, about 2.0 wt. % to about 2.5 wt. %, about 0.05 wt. % to about 2.0 wt. %, about 0.05 wt. % to about 1.5 wt. %, about 0.05 wt. % to about 1.0 wt. %, about 0.05 wt. % to about 0.5 wt. %, or about 0.05 wt. % to about 0.1 wt. %. In some embodiments, the caseins may be present in the composition in an amount of from about 0.05 wt. % to about 2.5 wt. %. The caseins present in the composition do not exceed 2.6 wt. %. The plant protein may be any cereal, legume, or seed-based protein isolate or concentrate and may be present in the composition in an amount from about 0.05 wt. % to about 2.0 wt. %, about 0.1 wt. % to about 2.0 wt. %, about 0.5 wt. % to about 2.0 wt. %, about 1.0 wt. % to about 2.0 wt. %, about 1.5 wt. % to about 2.0 wt. %, about 0.05 wt. % to about 1.5 wt. %, about 0.05 wt. % to about 1.0 wt. %, about 0.05 wt. % to about 0.5 wt. %, or about 0.05 wt. % to about 0.1 wt. %. In some embodiments, the plant protein may be any cereal, legume, or seed-based protein isolate or concentrate and may be present in the composition in an amount from about 0.05 wt. % to about 2 wt. %. The protein may be two different types of animal and/or recombinant milk proteins. The protein may be a single type of native milk protein or a single type of recombinant milk protein. The single type of protein may be β-casein.

The compositions disclosed herein are not used for cheese or yogurt, or cheese products or yogurt products. Further, k-casein is typically not used for whippable products described herein.

In some embodiments, the disclosed compositions may comprise a total κ-casein content in an amount of less than 0.03 wt. % based on the total composition. Amounts of less than 0.03 wt. % may help to avoid product instability caused by age gelation. K-casein may participate in sulfhydryl-disulfide exchange reactions with other proteins having sulfur-containing amino acids, leading to age gelation and subsequent instability. See: Nair and Corredig, Journal of Dairy Science, 2021; 104 (1): 92-101.

β-casein may be derived from bovine milk, such as whole milk (e.g., milk with about 3.5% milkfat), reduced-fat milk (e.g., milk with about 2% milkfat), low-fat milk (e.g., milk with about 1% milkfat), and fat-free milk (e.g., milk with about 0.8 wt. % or less milkfat). The β-casein may be separated from the other components of the milk to produce a β-casein that is purified to from about 45 wt. % to about 99 wt. % on a dry basis. For example, the β-casein may be purified to from about 45 wt. %, about 50 wt. %, about 55 wt. %, about 60 wt. %, about 65 wt. %, about 70 wt. %, about 75 wt. %, about 80 wt. %, about 83 wt. %, about 86 wt. %, about 89 wt. %, about 91 wt. %, about 92 wt. %, about 93 wt. %, or about 99 wt. % on a dry basis.

The β-casein may be recombinant and comprises an amino acid sequence that may be from about 60% to about 100%, about 70% to about 100%, about 80% to about 100%, about 90% to about 100%, about 60% to about 90%, about 60% to about 80%, or about 60% to about 70% identical to an amino acid sequence of a cow milk protein, sheep milk protein, horse milk protein, or goat milk protein.

b. Fat

One or more fats are useful in the compositions disclosed herein. The fat may be a dairy fat, a vegetal fat, vegetal oil, algal, fungal, recombinantly produced, or a combination thereof. The fat may be fully hydrogenated, partially hydrogenated, interesterified, or hydrogenated and interesterified or a combination of thereof with or without unmodified fat. The composition may comprise from about 5 wt. % to about 45 wt. %, about 10 wt. % to about 45 wt. %, about 15 wt. % to about 45 wt. %, about 20 wt. % to about 45 wt. %, about 25 wt. % to about 45 wt. %, about 30 wt. % to about 45 wt. %, about 35 wt. % to about 45 wt. %, about 40 wt. % to about 45 wt. %, about 5 wt. % to about 40 wt. %, about 5 wt. % to about 35 wt. %, about 5 wt. % to about 30 wt. %, about 5 wt. % to about 25 wt. %, about 5 wt. % to about 20 wt. %, about 5 wt. % to about 15 wt. %, or about 5 wt. % to about 10 wt. % of the fat. In some embodiments, the composition may comprise from about 25 wt. % to about 35 wt. % of the fat.

The fat may comprise one or more lipids derived from a plant, one or more lipids derived from milk, or a combination thereof.

The fat may comprise one or more monoglycerides, diglycerides, triglycerides, and/or phospholipids comprising a short chain fatty acid selected from the group consisting of butyric acid, caproic acid, caprylic acid, and capric acid. The one or more monoglycerides, diglycerides, triglycerides, and/or phospholipids may be a plant-based trans-esterified monoglyceride, diglyceride, triglyceride, and/or phospholipid. The one or more monoglycerides, diglycerides, triglycerides, and/or phospholipids may comprise fatty acyl chains in a percentage that resembles a percentage of the fatty acyl chains found in a mammal-derived milk or dairy product.

c. Sweetener

The composition may comprise from about 0 wt. % to about 45 wt. %, about 5 wt. % to about 45 wt. %, about 10 wt. % to about 45 wt. %, about 15 wt. % to about 45 wt. %, about 20 wt. % to about 45 wt. %, about 25 wt. % to about 45 wt. %, about 30 wt. % to about 45 wt. %, about 35 wt. % to about 45 wt. %, about 40 wt. % to about 45 wt. %, about 0 wt. % to about 40 wt. %, about 0 wt. % to about 35 wt. %, about 0 wt. % to about 30 wt. %, about 0 wt. % to about 25 wt. %, about 0 wt. % to about 20 wt. %, about 0 wt. % to about 15 wt. %, about 0 wt. % to about 10 wt. %, or about 0 wt. % to about 5 wt. % of a sweetener. In some embodiments, the composition may comprise from about 5 wt. % to about 25 wt. % of a sweetener. The sweetener may be a nutritive sweetener or a non-nutritive sweetener. The nutritive sweetener may be one or more of sucrose, lactose, glucose, fructose, corn syrup solids, high-fructose corn syrup, dextrose, maltodextrin, brown sugar, honey, and maple syrup. The non-nutritive sweetener may be one or more of sucralose, aspartame, saccharin, stevia, monk fruit extract, neotame, advantame, and acesulfame potassium. The sweetener may be one or more of brazzein, curculin, mabinlin, miraculin, monelin, pentadin, and thaumatin.

d. Stabilizer

The composition may comprise from about 0 wt. % to about 3 wt. %, about 0.5 wt. % to about 3 wt. %, about 1 wt. % to about 3 wt. %, about 1.5 wt. % to about 3 wt. %, about 2 wt. % to about 3 wt. %, about 2.5 wt. % to about 3 wt. %, about 0 wt. % to about 2.5 wt. %, about 0 wt. % to about 2 wt. %, about 0 wt. % to about 1.5 wt. %, about 0 wt. % to about 1 wt. %, or about 0 wt. % to about 0.5 wt. % of one or more stabilizers. In some embodiments, the composition may comprise from about 0.5 wt. % to about 1 wt. % of one or more stabilizers. The stabilizer may be one or more of alginate, carrageenan, guar gum, microcrystalline cellulose, carboxymethylcellulose, sorbitol, hydroxypropyl methylcellulose (HPMC), xanthan gum, tara gum, and locust bean gum. The stabilizers may be one or more of alginate, carrageenan, guar gum, cellulose; e.g., methyl cellulose, microcrystalline cellulose, carboxymethylcellulose, sorbitol, hydroxypropyl methylcellulose (HPMC), xanthan gum, tara gum, locust bean gum, gellan gum, beet pectin, plant proteins, sodium caseinate, skim milk powder, milk protein isolate/concentrate, micellar casein isolate/concentrate, acid casein powder, rennet casein powder, whey protein concentrate/isolate powder, dairy products solids, whole milk powder, partly skimmed milk powder, butter milk powder, modified starch, agar-agar, gelatine, gellan (e.g., high acyl, low acyl), gum Arabic, konjac, pectin, maltodextrin, tragacanth, or a combination thereof.

A stabilizer may maintain a degree of homogeneity in the compositions. In some embodiments, the stabilizer may act as an emulsifier that complements the casein protein. When they help stabilize the finely emulsified fat and/or oil globules that scatter light in the emulsions, the stabilizers may also function as a whitener.

e. Buffer Salts

The composition may comprise from about 0.0001 wt. % to about 2 wt. %, about 0.001 wt. % to about 2 wt. %, about 0.01 wt. % to about 2 wt. %, about 0.1 wt. % to about 2 wt. %, about 1 wt. % to about 2 wt. %, about 1.5 wt. % to about 2 wt. %, about 0.0001 wt. % to about 1.5 wt. %, about 0.0001 wt. % to about 1 wt. %, about 0.0001 wt. % to about 0.1 wt. %, about 0.0001 wt. % to about 0.01 wt. %, or about 0.0001 wt. % to about 0.001 wt. % of buffer salts. In some embodiments, the composition may comprise from about 0.5 wt. % to about 1 wt. % of buffer salts. The buffer salt may be one or more of phosphate salt, halide salt, carbonates, bicarbonates, tartrates, and citrate salt.

f. Bulking Agents

The composition may comprise from about 0 wt. % to about 50 wt. %, about 10 wt. % to about 50 wt. %, about 20 wt. % to about 50 wt. %, about 30 wt. % to about 50 wt. %, about 40 wt. % to about 50 wt. %, about 0 wt. % to about 40 wt. %, about 0 wt. % to about 30 wt. %, about 0 wt. % to about 20 wt. %, or about 0 wt. % to about 10 wt. % of bulking agents. The bulking agents may be one or more of high fructose corn syrup, starches, modified starches, and maltodextrose.

g. Emulsifiers

The composition may comprise from about 0 wt. % to about 3 wt. %, about 0 wt. % to about 0.5 wt. %, about 0 wt. % to about 1 wt. %, about 0 wt. % to about 1.5 wt. %, about 0 wt. % to about 2 wt. %, about 0 wt. % to about 2.5 wt. %, about 0.5 wt. % to about 3 wt. %, about 1 wt. % to about 3 wt. %, about 1.5 wt. % to about 3 wt. %, about 2 wt. % to about 3 wt. %, or about 2.5 wt. % to about 3 wt. % of one or more emulsifiers. In some embodiments, the composition may comprise from about 0.5 wt. % to about 1 wt. % of one or more emulsifiers. The emulsifier may be one or more of diacetyl tartaric acid esters of mono- and/or diglycerides, lactic acid esters of mono- and/or diglycerides, sodium stearoyl lactylate, lecithin, sorbitan monostearate, polyglycol ester, propylene glycol monostearate, polysorbate, polysorbate 60, polysorbate 80, sucrose esters, sucrose monostearate, and monoglyceride. The emulsifiers may be one or more of sugar esters, beeswax, carnauba wax, candelilla wax, plant waxes, fruit waxes, animal waxes, polyglycerol fatty acid esters, polyglycerol polyricinoleate (PGPR), polysorbates (polyoxyethylene sorbitan esters), monoglycerides, diglycerides, diacetyl tartaric acid esters of mono- and/or diglycerides, lactic acid esters of mono- and/or diglycerides, sodium stearoyl lactylate, sorbitan monostearate, polyglycol ester, propylene glycol monostearate, and lecithin. Notably, waxes may act as fat modifiers more so than emulsifiers due to their minimal surface-active properties.

### 3. Methods of Making a β-Casein Comprising Composition

Provided herein are methods of making a composition as described herein. The methods may include forming an oil phase comprising the fat; forming an aqueous phase comprising the protein; heating the oil phase and aqueous phase from about 15° C. to about 75° C., about 25° C. to about 75° C., about 35° C. to about 75° C., about 45° C. to about 75° C., about 55° C. to about 75° C., about 65° C. to about 75° C., about 15° C. to about 65° C., about 15° C. to about 55° C., about 15° C. to about 45° C., about 15° C. to about 35° C., or about 15° C. to about 25° C.; mixing the oil phase and the aqueous phase to form a mixture; homogenizing the mixture to form an emulsion; heating the emulsion to from about 60° C. to about 150° C., about 60° C. to about 140° C., about 60° C. to about 130° C., about 60° C. to about 120° C., about 60° C. to about 110° C., about 60° C. to about 100° C., about 60° C. to about 90° C., about 60° C. to about 80° C., about 60° C. to about 70° C., about 70° C. to about 150° C., about 80° C. to about 150° C., about 90° C. to about 150° C., about 100° C. to about 150° C., about 110° C. to about 150° C., about 120° C. to about 150° C., about 130° C. to about 150° C., or about 140° C. to about 150° C.; and cooling the emulsion to from about 2° C. to about 30° C., about 4° C. to about 30° C., about 8° C. to about 30° C., about 16° C. to about 30° C., about 2° C. to about 16° C., about 2° C. to about 8° C., or about 2° C. to about 4° C. The emulsion may be heated to pasteurization (e.g., at least about 72° C. for at least about 15 seconds) and UHT pasteurization levels (e.g., from about 135° C. to about 154° C., such as about 145° C., for about 1 second to about 8 seconds), followed by packing in non-sterile or sterile environments. The storage temperature can vary-frozen (e.g., from about −18° C. to about −15° C.), refrigerated (e.g., from about 3° C. to about 5° C.), or ambient (e.g., from about 18° C. to about 25° C.)-based on the specific heat treatment and packaging. The method may further comprise packing the emulsion. Packing may include, but is not limited to, in bags, in brick format (e.g., 250 mL to half a gallon), in jugs (e.g., 250 mL to gallon jug), in a bag in a box (up to 20 pounds), in totes, in cake decorating bags, and the like. The aqueous phase may further comprise stabilizers, emulsifiers, and buffering salts. The method may further comprise aerating the emulsion. Aerating may comprise whisking, mixing using a planetary mixer, or whipping using a continuous whipping machine. The method may further comprise heat treating, pasteurizing, or sterilizing the emulsion. The heat treating, pasteurizing, or sterilizing may comprise retort, high hydrostatic pressure, or ultra-high temperature processing. The emulsion may have an improved storage stability compared to a corresponding emulsion. A whipped emulsion may be prepared by whipping the emulsion of as described herein the whipping at from about 2° C. to about 8° C., about 3° C. to about 8° C., about 4° C. to about 8° C., about 5° C. to about 8° C., about 6° C. to about 8° C., about 7° C. to about 8° C., about 2° C. to about 7° C., about 2° C. to about 6° C., about 2° C. to about 5° C., about 2° C. to about 4° C., or about 2° C. to about 3° C.

### 4. Food Product

Described herein is a food product comprising a composition as described herein. The food product may be a dairy product or non-dairy product such as a coffee creamer, a cooking cream, a whipping cream, or a similar low to high fat emulsion. The food product may comprise from about 0.001 wt. % to about 3 wt. %, about 0.01 wt. % to about 3 wt. %, about 0.1 wt. % to about 3 wt. %, about 1 wt. % to about 3 wt. %, about 2 wt. % to about 3 wt. %, about 0.001 wt. % to about 2 wt. %, about 0.001 wt. % to about 1 wt. %, about 0.001 wt. % to about 0.1 wt. %, or about 0.001 wt. % to about 0.01 wt. % of the protein. The food product may comprise from about 0.1 wt. % to about 2.5 wt. %, about 0.5 wt. % to about 2.5 wt. %, about 1 wt. % to about 2.5 wt. %, about 1.5 wt. % to about 2.5 wt. %, about 2.0 wt. % to about 2.5 wt. %, about 0.1 wt. % to about 2.0 wt. %, about 0.1 wt. % to about 1.5 wt. %, about 0.1 wt. % to about 1 wt. %, or about 0.1 wt. % to about 0.5 wt. % total casein.

### 5. Examples

The foregoing may be better understood by reference to the following examples, which are presented for purposes of illustration and are not intended to limit the scope of the invention. The present disclosure has multiple aspects and embodiments, illustrated by the appended non-limiting examples.

### Example 1

Separation of β-Casein from Milk

It was hypothesized that β-caseins may be primarily responsible for the high functionality of sodium caseinates. To develop β-casein enriched protein solutions, the starting material can be either reconstituted micellar casein powder or skim milk. Unlike the other two main fractions of casein, αS- and k-casein, the dissociation of β-casein from the micelle is temperature dependent. β-casein dissociates from the casein micelle into the serum phase upon cooling of milk to the temperatures below 5° C., which is a reversible process. Using microfiltration (MF), β-casein can be separated from skim milk at cold temperatures. For the current process, a slight modification of the method described by Hoffmann et al., (2006) Kieler Milchwirtschaftliche Forschungsberichte, 58 (1), 41-51 and Schafer et al., (2019) International Dairy Journal, 97, 222-229 was used. This includes MF at low temperatures and subsequent concentration of the MF permeate using an ultrafiltration (UF) process.

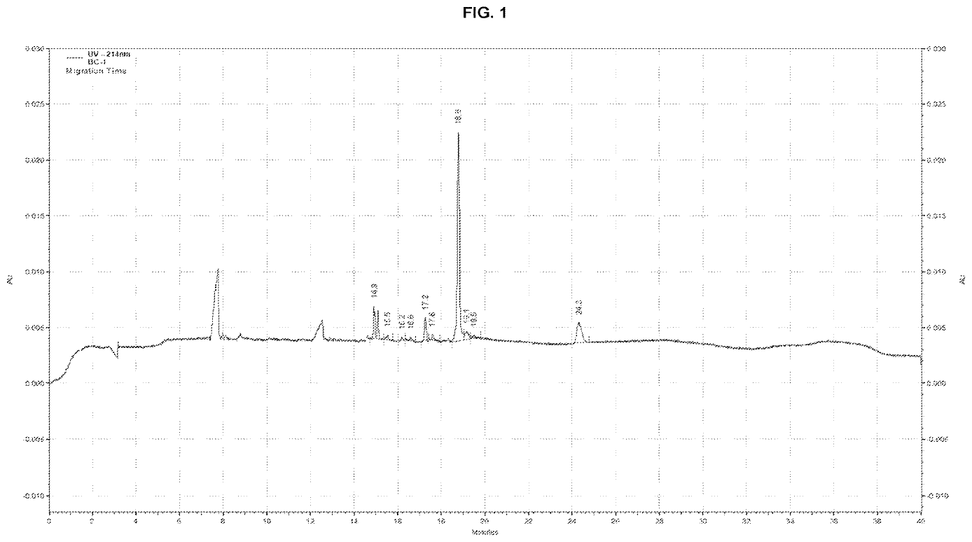

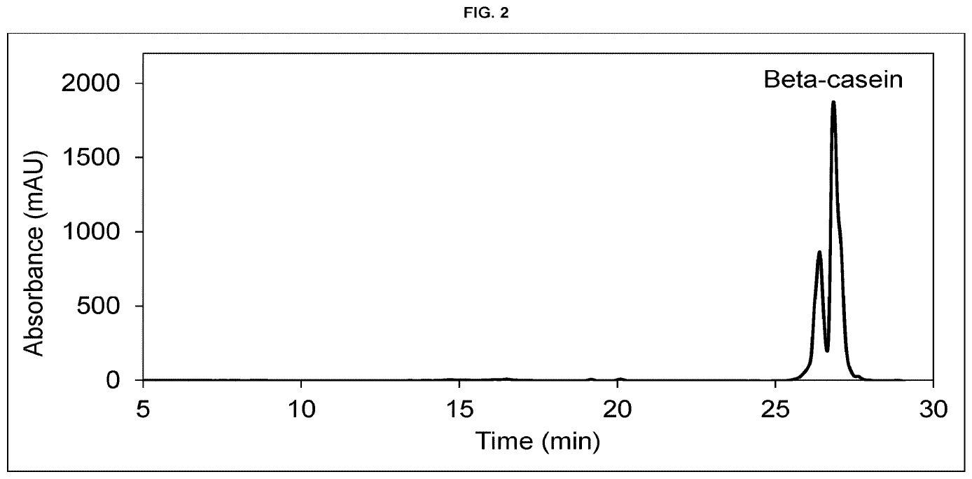

The skim milk or micellar casein or milk protein solution (protein content adjusted to 3.5% using deionized water) was microfiltered at 55° C. to separate soluble whey proteins from caseins. A retentate rich in casein micelles and a permeate rich in whey protein were obtained. The later part was discarded, and the former part was again adjusted to protein content of 3.5% using deionized water. This was further microfiltered to remove permeate rich in whey protein fractions. This diafiltration step may be repeated to reduce the content of whey proteins. The retentate was diluted back to get the original protein content as skimmed milk using deionized water. This solution was kept under cold temperatures (<4° C.) for 48-72 hours, as β-casein dissociates from the casein micelles at low temperatures due to weakening of hydrophobic interactions. This solution was then microfiltered at 4° C. using a 100 KDa membrane to get a permeate enriched with β-casein along with whey proteins. The retentate obtained was discarded. Later, this solution was concentrated using ultrafiltration (10 KDa membrane) to yield a retentate enriched with β-casein. This retentate solution was titrated against 1 N HCl to precipitate the β-casein at about pH 4.6. This slurry was centrifuged at 4000 g for 35 minutes to separate the β-casein enriched precipitate from whey proteins present in serum. The precipitate was further washed with de-ionized water to remove residual whey proteins. The precipitated β-casein was mixed with water to get a slurry containing 20-30% TS and was titrated back to pH 6.7 using 0.01 N NaOH. This solution was slowly warmed up to 65° C. to solubilize the β-casein solution fully. The protein composition of the starting material and resulting UF retentate was analyzed using capillary electrophoresis (FIG. 1) and HPLC (FIG. 2). The composition is shown in Table 1. This β-casein protein enriched solution was used for developing liquid emulsion compositions and high-fat emulsions which can be aerated with greater stability than sodium caseinate alone.

TABLE 1
Percentage of caseins in composition of three separate experiments

| Type of Casein | % |
|---|---|
| β-Casein | 89.8 ± 2.4 |
| α-S1 | 8.5 ± 1.5 |
| α-S2 | 1.4 ± 0.6 |
| κ-Casein | Not detected |

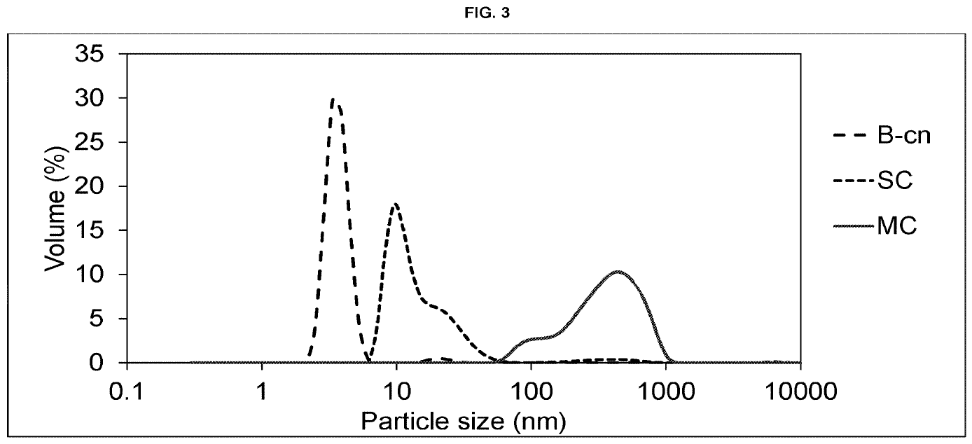

This shows that β-casein was able to be concentrated from other caseins and whey proteins, increasing the proportion of αS1-, αS2-, β-, and κ-caseins to 1:0:12:0. In FIG. 3, the mean protein particle size density (PSD) was measured using dynamic light scattering of the β-casein and it was found that the PSD was around 6 nm. This confirmed that the β-casein was in monomeric form, while sodium caseinate had some aggregates and the micellar casein concentrate was still in intact micellar form.

### Example 2

### Surface Tension of β-Casein Comprising Solutions

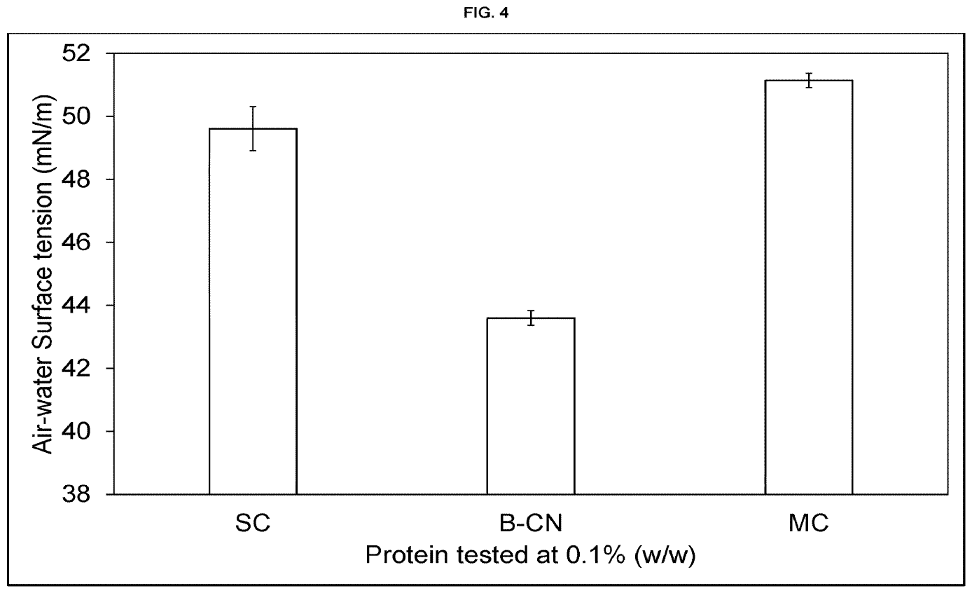

The surface tension reduction of the solutions was measured. The solutions were diluted 10× to assess their ability to lower the air-water and oil-water interfacial tension. It was clear from FIG. 4 that the higher purity β-casein sample lowered the surface tension to a greater extent than sodium caseinate and casein in its micellar form.

### Example 3

Emulsions made with β-Casein Comprising Solutions

Three-ingredient oil in water emulsions (oil, water, and protein) were prepared using 20% canola oil and 1% protein (w/w) processed at room temperature and homogenized at 2500 psi (1st stage) and 500 psi (2nd stage). As a control, sodium caseinate (NaCas) was used instead of β-casein. The finished product was subjected to particle size measurement via Mastersizer and foamability study by planetary mixer.

TABLE 2
Means for PSD of simple emulsions measured by Mastersizer

| | Dx (10) | Dx (50) | Dx (90) | D [4, 3] | |
|---|---|---|---|---|---|
| Sample | (μm) | (μm) | (μm) | (μm) | Span (90, 10) |
| Control - | 0.0445 | 0.414 | 2.56 | 1.0715 | 6.0725 |
| NaCas | | | | | |
| BCN 100% | 0.0836 | 0.484 | 2.29 | 0.91 | 4.558 |
| replacement | | | | | |

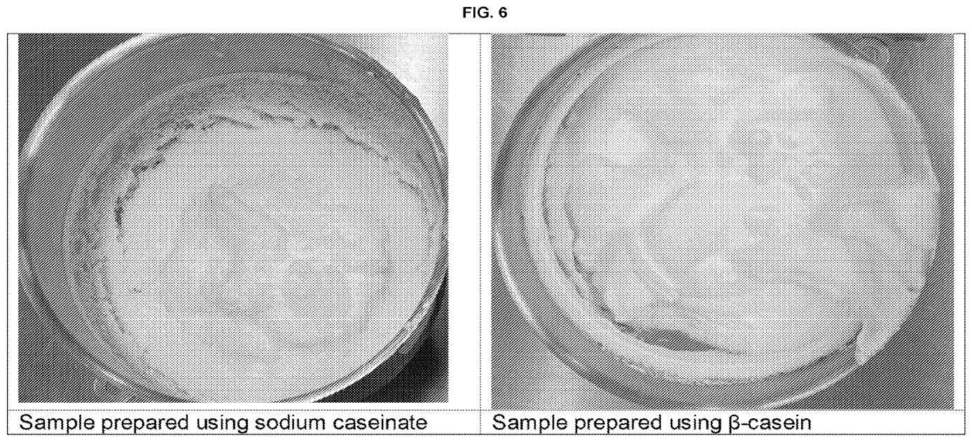

The foaming properties of the samples were analyzed, and the results are shown in FIG. 6. The samples were subjected to aeration using a kitchen-aid whipping apparatus. The samples with β-casein had better foaming and foam stability compared with samples with sodium caseinate.

### Example 4

### Foaming Capacity of β-Casein Comprising Solutions

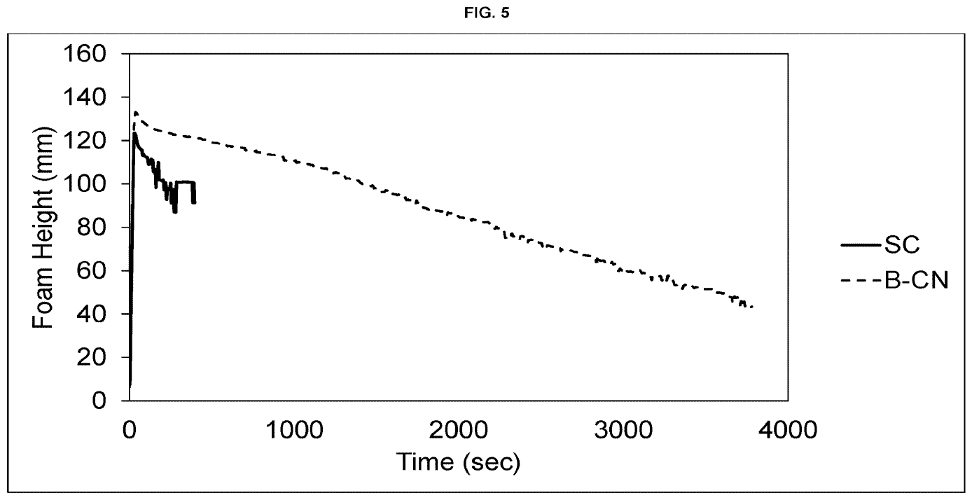

The foaming capacity of 0.25% protein solutions was tested to understand the functionality of the β-casein enriched solution compared to control sodium caseinate. Both proteins foamed quite rapidly, however, the β-casein solution showed much greater foam stability than sodium caseinate (FIG. 5). This is evidenced by the much longer decay of foam height compared to sodium caseinate which collapsed in the initial 10 minutes of testing.

### Example 5

### Whipped Topping Emulsions Comprising β-Casein

Complex emulsions containing multiple ingredients, simulating commercial aerated/whipped toppings were prepared.

TABLE 3
Recipe for the whipped topping application with 100% substitution

| Ingredient | Control (%) | β-casein sample (%) |
|---|---|---|
| Vegetable oil (palm kernel oil) | 20 | 20 |
| Sugar | 30 | 30 |
| Sodium caseinate | 1 | 0 |
| b-casein solution (dry basis) | 0 | 1 |
| Emulsifiers (polysorbate | 0.5 | 0.5 |
| 60/sodium stearoyl | | |
| lactylate/mono & diglycerides) | | |
| Stabilizers | 0.5 | 0.5 |

Water to make up to 100

TABLE 4
Means for PSD of Gold Label liquid topping product
with sodium caseinate and beta-casein

| | Dx (10) | Dx (50) | Dx (90) | D [4, 3] | |
|---|---|---|---|---|---|
| Sample | (μm) | (μm) | (μm) | (μm) | Span (90, 10) |
| Control NaCas | 0.0449 | 0.220 | 0.877 | 2.14 | 3.784 |
| BCN 100% | 0.0943 | 0.289 | 0.691 | 0.350 | 2.066 |
| replacement | | | | | |

TABLE 5
Whipping results on a KitchenAid Mixer

| | Control Caseinate | Beta-casein |
|---|---|---|
| Date Made | Sep. 9, 2022 | Sep. 9, 2022 |
| Date Tested | Sep. 16, 2022 | Sep. 16, 2022 |
| Whip Time (min) | 4 | 4 |
| Overrun (%) | 296 | 323 |
| Penetrometer (t = 0 min) | 40.7 | 41.6 |
| Viscosity S3 (cPs/torque) | 627/62.7 | 185/18.5 |
| 100 rpm | | |
| Rosette Time (min) | 120 | 120 |

Bowl and Cake Application

| | | |
|---|---|---|
| Coarseness Rating | Fine grain | Smooth |
| Shininess Rating | Semi-dull/reflects little | Soft sheen |
| Firmness Rating | Soft-firm | Soft-firm |

### Example 6

### Whipped Topping Emulsions Comprising Reduced β-Casein

Given the excellent results with 1:1 replacement of sodium caseinate with beta-casein in whipped topping application, protein reductions were also assessed.

TABLE 6
Recipe for whipped topping application with protein reductions

| | | β-casein sample | β-casein sample |
|---|---|---|---|
| Ingredient | Control | (25% reduction) | (50% reduction) |
| Vegetable oil (palm | 20% | 20% | 20% |
| kernel oil) | | | |
| Sugar | 30% | 30% | 30% |
| Sodium caseinate | 1% | 0% | 0% |
| b-casein solution (dry | 0% | 0.75% | 0.5% |
| basis) | | | |
| Emulsifiers (polysorbate | 0.5% | 0.5% | 0.5% |
| 60/sodium stearoyl | | | |
| lactylate/mono & | | | |
| diglycerides) | | | |
| Stabilizers | 0.5% | 0.5% | 0.5% |

Water to make up to 100%

These results indicate that it is possible to add less beta-casein to achieve similar product characteristics and performance as the control. This is evidenced by the similar PSD results show in Table 7. The whipping characteristics were also improved with lower product viscosity, slightly higher whipping time, but extended rosette time and stability on the cake (Table 8).

TABLE 7
PSD for Gold Label liquid topping product made
with reduced beta-casein protein content.

| | Dx (10) | Dx (50) | Dx (90) | D [4, 3] | |
|---|---|---|---|---|---|
| Sample | (μm) | (μm) | (μm) | (μm) | Span (90, 10) |
| GL Control | 0.0575 | 0.246 | 0.722 | 0.346 | 2.701 |
| GL BCN 25% | 0.0581 | 0.264 | 0.793 | 0.358 | 2.787 |
| reduced | | | | | |
| GL BCN 50% | 0.062 | 0.283 | 0.839 | 0.382 | 2.743 |
| reduced | | | | | |

TABLE 8
Whipping results on a Hobart Mixer at
Speed 2 with 660 g of liquid topping.

| | 10-4 GL-A | 10-4 GL-B | 10-4 GL-C |
|---|---|---|---|
| | control | (25% reduced | (50% reduced |
| | caseinate | β-CN) | β-CN) |
| Whip Time (min) | 8:30 | 12:30 | 11:00 |
| Overrun (%) | 366% | 336% | 376% |
| Rosette Time (min) | 35 | 50 | 45 |
| Bench Time (min) | 40 | 55 | 50 |
| Penetrometer (mm) | 38.5 | 38 | 37.5 |

Bowl and Cake Application

| | | | |
|---|---|---|---|
| Coarseness | Smooth with fine | Smooth | Smooth |
| | grain | | |
| Shininess | Semi-glossy | Soft sheen | Semi-glossy |
| Firmness | Soft | Soft-firm | Firm |

### Example 7

### Sodium Caseinate Emulsions Comprising β-Casein

β-casein was added to sodium caseinate to change the ratio of β-casein to total casein content. In general, β-casein constitutes 33-37% of the total casein. Various ratios of β-casein formulations were examined. In the following example, the β-casein content was increased from 37% to 50%, 65%, 75%, and 90% by mixing various levels of β-casein solutions with sodium caseinate or only β-casein solutions while keeping the total protein content same across all formulations. The emulsions were made with 20% canola oil and 1% protein processed at 2500/500 psi pressure in a two-stage homogenizer. Table 9 shows that increasing the β-casein content of sodium caseinate can lead to superior emulsion properties.

TABLE 9
Means for PSD of simple emulsions with blends
of sodium caseinate and beta-casein.

| | Dx (10) | Dx (50) | Dx (90) | D [4, 3] |
|---|---|---|---|---|
| Sample | (μm) | (μm) | (μm) | (μm) |
| 100% NaCas | 0.0476 | 0.456 | 2.86 | 1.04 |
| 75% NaCas 25% BCN | 0.0495 | 0.392 | 1.93 | 0.747 |
| 50% NaCas/50% BCN | 0.057 | 0.434 | 2.26 | 0.874 |
| 25% NaCas 75% BCN | 0.0607 | 0.285 | 1.44 | 0.569 |
| 100% BCN | 0.0767 | 0.522 | 2.5 | 1.01 |

### Example 8

### Whipped Topping Sodium Caseinate Emulsions Comprising β-Casein

In another embodiment, β-casein was added to sodium caseinate to change the ratio of β-casein to total casein content and applied to a whipped topping product. In the following example, the β-casein content was increased to 50 and 55% by mixing β-casein extract and sodium caseinate.

TABLE 10
Recipe for whipped topping product with
sodium caseinate spiked with beta casein.

| | Control | 50% Spiked NaCas | 75% Spiked NaCas |
|---|---|---|---|
| Ingredient | (%) | with BCN (%) | with BCN (%) |
| Vegetable oil (palm | 20 | 20 | 20 |
| kernel oil) | | | |
| Sugar | 30 | 30 | 30 |
| Sodium caseinate | 1 | 0.5 | 0.25 |
| b-casein solution | 0 | 0.5 | 0.75 |
| (dry basis) | | | |
| Emulsifiers | 0.5 | 0.5 | 0.5 |
| (polysorbate | | | |
| 60/sodium stearoyl | | | |
| lactylate/mono & | | | |
| diglycerides) | | | |
| Stabilizers | 0.5 | 0.5 | 0.5 |

Water to make up to 100

TABLE 11
Means for PSD of whipped topping samples made
with spiked sodium caseinate/beta casein.

| | Dx (10) | Dx (50) | Dx (90) | D [4, 3] | D [3, 2] |
|---|---|---|---|---|---|
| Sample | (μm) | (μm) | (μm) | (μm) | (μm) |
| Control | 0.0551 | 0.227 | 0.69 | 0.685 | 0.127 |
| 100% | | | | | |
| caseinate | | | | | |
| Spiked 50% | 0.0468 | 0.207 | 0.671 | 0.501 | 0.111 |
| with beta | | | | | |
| casein | | | | | |
| Spiked 75% | 0.0449 | 0.189 | 0.546 | 0.25 | 0.105 |
| with beta | | | | | |
| casein | | | | | |

### Example 9

### Non-Whippable Coffee Creamers Comprising β-Casein

In another embodiment, β-casein was incorporated into non-whippable low-fat and high-fat coffee creamer formulations using non-hydrogenated vegetable fats and milk fat, respectively. Varying sugar contents were also utilized, as well as different supporting emulsifiers including polysorbate-60 and monoglycerides and diglycerides of fatty acids. Salts such as sodium chloride and dipotassium phosphates were included for taste and to prevent feathering. Table 12 shows formulations that were heat treated and homogenized downstream at 2500/500 psi pressure in a two-stage homogenizer. Table 13 shows the resulting emulsion properties indicating the low viscosity and small particle sizes obtained after processing and refrigerated storage. The resultant products (i.e., samples C and D) showed good stability in coffee with no visible feathering.

TABLE 12
Recipes for non-whippable coffee creamer
products with beta casein.

Sample

| Ingredients | C | D |
|---|---|---|
| Non-hydrogenated palm kernel and coconut blend | 5 | |
| Anhydrous milk fat | | 30 |
| Granulated Sugar | 10 | 4.5 |
| Polysorbate-60 | | 0.3 |
| Mono & Diglycerides | 0.3 | |
| Salt (Sodium Chloride) | 0.3 | 0.3 |
| Dipotassium Phosphate | 0.2 | 0.5 |
| Beta-casein solution (dry basis) | 1.0 | 1.5 |

Water to make up to 100%

TABLE 13
Average particle size, liquid separation,
and viscosity of coffee creamers.

Sample

| Parameters | C | D |
|---|---|---|
| Particle Size - Dx (10) (μm) | 0.16 | 0.19 |
| Particle Size - Dx (50) (μm) | 0.46 | 0.54 |
| Particle Size - Dx (90) (μm) | 1.36 | 1.62 |
| Particle Size - D [4, 3] (μm) | 0.70 | 0.77 |
| Particle Size - D [3, 2] (μm) | 0.34 | 0.39 |
| Liquid separation - 3 weeks (mm) | 10 | 1 |
| DVT Brookfield viscosity 100 rpm | <100/2/S1 | <100/5/S1 |
| (cP/% torque/Spindle) | | |

### Example 10

### Whipped Topping Sodium Caseinate Emulsions Comprising β-Casein

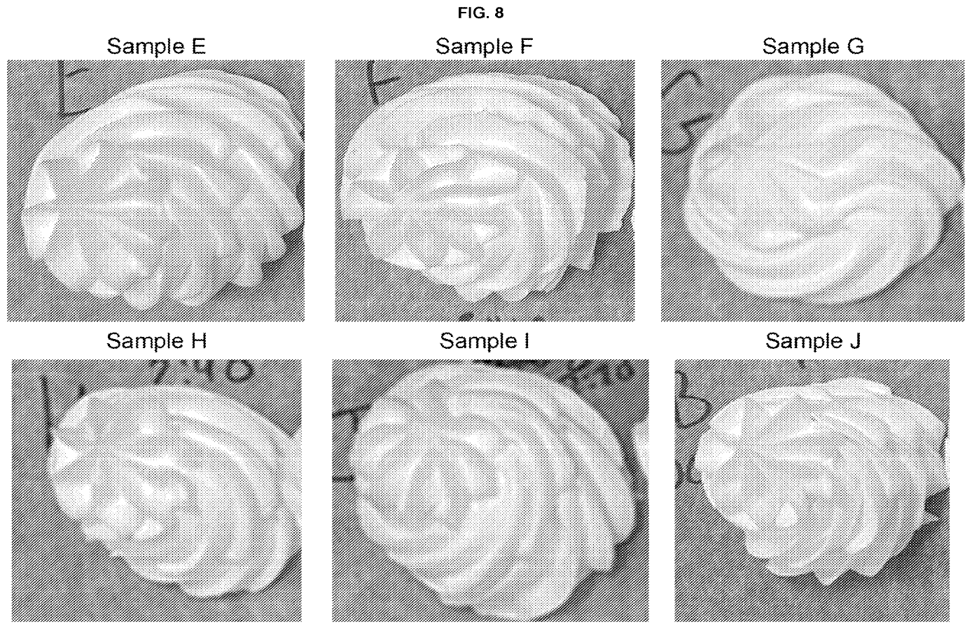

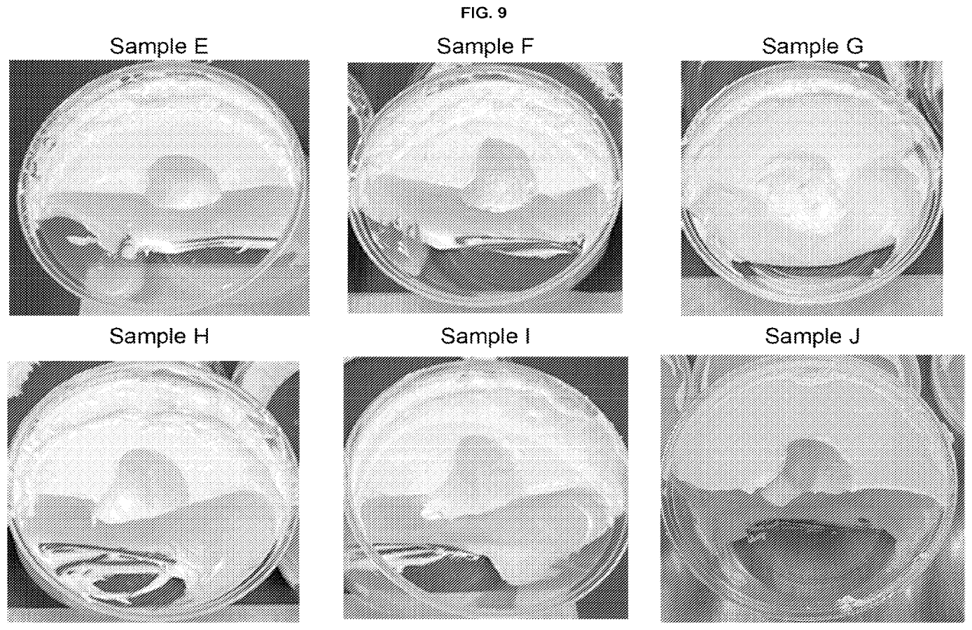

In another embodiment, β-casein was incorporated into various whippable low, medium, and high-fat toppings, frosting, and soft foam formulations. In these formulations, various oils, not limited to hydrogenated vegetable fats from palm kernel and coconut oil, were used over a range of concentrations. Sweeteners were included, such as corn syrups (HFCS 42, 43/43, 36DE), dextrose, granulated sugar, and lactose, to reach a total sweetener content of 16-60%. Many different emulsifiers showed compatibility with β-casein, such as soy lecithin, distilled monoacylglycerol, polysorbate-60, soy protein concentrate, sodium stearoyl lactylate, polyglycerol esters of fatty acids, and sorbitan monostearate. Various stabilizers were used to improve product stability and included sodium alginate, hydroxypropylmethyl cellulose, xanthan gum, guar gum, locust bean gum, corn starch, and carrageenan. Other dairy ingredients such as cream powder and buttermilk powder can also be used to improve the dairy flavor profile in imitation creams. The various compositions (i.e., samples E, F, G, H, I, and J) are shown in Table 14. Table 15 shows the resulting properties of the compositions. The initial whipped product appearance is shown in FIG. 8. FIG. 8 shows the initial rosette as dispensed from a standard pastry bag with a star tip right after whipping. Stability bowls comprising the samples after 24 hours of refrigeration (i.e., from about 2° C. to about 4° C.) are shown in FIG. 9. FIG. 9 shows the appearance of product after 150 g of the product was placed in a deli container and stored in refrigeration. A spoon was used to take a small amount out of the cup to show the internal foam structure and stability of the whipped cream.

TABLE 14
Recipes for whippable toppings, frostings,
and foams comprising beta-casein.

| | Samples | | | | | |
|---|---|---|---|---|---|---|
| Ingredient | E | F | G | H | I | J |
| High-Fructose Corn Syrup 42 | | 30 | | | 52 | 10.5 |
| Fully Hydrogenated Palm | 14 | 22 | 12.0 | 28 | 18 | 27.0 |
| Kernel Oil | | | | | | |
| Hydrogenated Coconut Oil | | | 6.0 | | | |
| Corn Syrup 43/43 | | | 7.0 | 9 | | |
| Corn Syrup 36DE | 18 | | | | 7 | |
| Dextrose | | | | 0.45 | | 8.0 |
| Granulated Sugar | 11 | | 6.8 | 16 | | 23.0 |
| Cream Powder | | | 3.3 | | | |
| Buttermilk Powder | | | 3 | | | |
| Lactose | | | 2.5 | | | |
| Soy Lecithin | | | 0.1 | | | |
| Distilled Monoglyceride | 0.07 | | | | | |
| Polysorbate-60 | 0.45 | 0.3 | 0.1 | 0.3 | 0.3 | 0.3 |
| Soy Protein Concentrate | | | | | 0.1 | 0.1 |
| Sodium Stearoyl Lactylate | 0.3 | | | | | |
| Polyglycerol Esters of Fatty | | | | | 0.1 | 0.1 |
| Acids | | | | | | |
| Mono & Diglycerides | 0.1 | 0.15 | 0.3 | | | |
| Sorbitan Monostearate | | | | 0.2 | | |
| Salt (Sodium Chloride) | 0.1 | | | | 0.15 | 0.1 |
| Potassium Sorbate | | | | | 0.1 | 0.1 |
| Sodium Alginate | 0.05 | 0.05 | | | | |
| Disodium Phosphate | | | 0.1 | | | |
| Hydroxypropylmethyl | 0.2 | | | | | |
| cellulose blend | | | | | | |
| Hydroxypropylmethyl | 0.2 | 0.36 | | | 0.25 | 0.3 |
| cellulose F50 | | | | | | |
| Xanthan Gum | 0.05 | | | 0.1 | 0.05 | 0.04 |
| Guar Gum | 0.1 | | 0.10 | 0.1 | | |
| Locust Bean Gum | | | 0.10 | | | |
| Modified Corn Starch | | | 0.30 | | | |
| Carrageenan | | | 0.05 | | | |
| Beta-casein solution (dry | 0.1 | 0.8 | 0.3 | 1.2 | 1.2 | 2.0 |
| basis) | | | | | | |

Water to make up to 100%

TABLE 15
Emulsion properties and whipped performance of toppings,
frostings and foams after these emulsions were undergone
freezing and thawing at refrigerated temperature.

| Sample | E | F | G | H | I | J |
|---|---|---|---|---|---|---|
| Storage/ | Freeze/ | Freeze/ | Freeze/ | Freeze/ | Freeze/ | Refrigerated |
| Treatment | thaw | thaw | thaw | thaw | thaw | |
| Particle Size - | 0.05 | 0.14 | 0.27 | 0.12 | 0.22 | 0.10 |
| Dx (10) (μm) | | | | | | |
| Particle Size - | 0.19 | 0.43 | 0.82 | 0.35 | 0.47 | 0.26 |
| Dx (50) (μm) | | | | | | |
| Particle Size - | 0.50 | 1.98 | 2.76 | 1.08 | 1.06 | 0.58 |
| Dx (90) (μm) | | | | | | |
| Particle Size - | 0.25 | 0.76 | 1.62 | 0.56 | 0.84 | 0.37 |
| D [4,3] (μm) | | | | | | |
| Particle Size - | 0.12 | 0.30 | 0.58 | 0.26 | 0.40 | 0.20 |
| D [3,2] (μm) | | | | | | |
| Liquid | 0 | 25 | 0 | 0 | 5 | |
| separation - | | | | | | |
| 3 weeks (mm) | | | | | | |
| DVT | 761/76.1/ | 240/24/ | 1840/46/ | 477/47.7/ | 429/42.9/ | 860/43.0/ |
| Brookfield | S3 | S3 | S5 | S3 | S3 | S4 |
| viscosity | | | | | | |
| 100 rpm | | | | | | |
| (cP/% torque/ | | | | | | |
| Spindle) | | | | | | |
| Liquid weight | 340 | 330 | 333 | 332 | 335 | 340.00 |
| in std Cup (g) | | | | | | |
| Whipped wt. | 74.3 | 84 | 120.6 | 120.1 | 104.2 | 102.10 |
| In std Cup (g) | | | | | | |
| Whip Time | 16.0 | 13.5 | 9.0 | 16.0 | 11.0 | 8:00 |
| (min) | | | | | | |
| Overrun (%) | 358 | 293 | 176 | 176 | 221 | 233 |
| Rosette time | 60 | 30 | 30 | 60 | 75 | |
| (min) | | | | | | |
| Penetrometer | 36 | 36.4 | >50 | 35 | 36.3 | 31.5 |
| (mm) | | | | | | |
| Coarseness - | smooth | gritty/ | smooth | fine grain | fine grain | very smooth |
| whipped | | small | | | | |
| | | pocks | | | | |
| Shininess - | semi- | semi- | soft sheen | semi- | semi- | semi- |
| whipped | glossy | glossy | | glossy | glossy | glossy |
| Firmness - | firm | stiff | soft | firm/stiff | firm | very firm |
| whipped | | | | | | |
| Stability - | excellent | good | poor | good | good | excellent |
| whipped - | | | | | | |
| 1 day | | | | | | |
| Stability - | good | poor | poor | good | good | excellent |
| whipped - | | | | | | |
| 2 days | | | | | | |
| Stability - | 0 | 0 | 0 | 0 | 0 | 0 |
| whipped - | | | | | | |
| syneresis | | | | | | |
| (mL) | | | | | | |

The foregoing description of the specific aspects will so fully reveal the general nature of the invention that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the invention are set out in the following numbered clauses:

Clause 1. An emulsion composition comprising a fat and a protein, wherein the protein comprises greater than 45 wt. % of β-casein based on the total amount of casein present in the composition.

Clause 2. The composition of clause 1, wherein the composition comprises: from about 5 wt. % to about 45 wt. % of the fat; from about 0.001 wt. % to about 3 wt. % of the protein; from about 0 wt. % to about 55 wt. % of a sweetener; from about 0 wt. % to about 3 wt. % of one or more stabilizers; from about 0.0001 wt. % to about 2 wt. % of buffer salts; and, from about 0 wt. % to about 3 wt. % of one or more emulsifiers.

Clause 3. The composition of clause 1 or clause 2, wherein the composition comprises: from about 5 wt. % to about 35 wt. % of the fat; from about 1 wt. % to about 2.5 wt. % of the protein; from about 5 wt. % to about 45 wt. % of a sweetener; from about 0.5 wt. % to about 3 wt. % of one or more stabilizers; from about 0.5 wt. % to about 2 wt. % of buffer salts; and, from about 0.5 wt. % to about 3 wt. % of one or more emulsifiers.

Clause 4. The composition of any one of clauses 1-3, wherein the fat is a dairy fat, a vegetal fat, vegetal oil, algal oil, fermented oil from bacteria, yeast or mold, hydrogenated oil, hydrogenated and interesterified oil, hydrogenated, blended and interesterified oil, medium-chain triglyceride (MCT) vegetable oil, milk fat, ghee, anhydrous milk fat, butter oil, or a combination thereof.

Clause 5. The composition of any one of clauses 1-4, wherein the protein is an animal protein, a recombinant milk protein, a plant-based protein, or a combination thereof.

Clause 6. The composition of any one of clauses 1-5, wherein the protein is natural casein, recombinant casein, or a combination thereof.

Clause 7. The composition of any one of clauses 1-6, wherein the composition comprises a total κ-casein content of less than 0.03 wt. % based on the total composition.

Clause 8. The composition of any one of clauses 1-7, wherein the protein is enriched in animal and/or recombinant β-casein.

Clause 9. The composition of any one of clauses 1-8, wherein the β-casein is natural or recombinant.

Clause 10. The composition of clause 9, wherein the β-casein is recombinant and comprises an amino acid sequence that is from about 60% to about 100% identical to an amino acid sequence of a mammalian milk protein such as a cow milk protein, a sheep milk protein, a camel milk protein, a yak milk protein, a buffalo milk protein, a horse milk protein, or a goat milk protein.

Clause 11. The composition of any one of clauses 1-10, wherein the proportion of the β-casein is from about 45% to about 100% of the total amount of casein in the composition.

Clause 12. The composition of any one of clauses 1-11, wherein the β-casein is in a micellar form or in a monomeric form; wherein when the β-casein is in a monomeric form, the β-casein has a protein particle size of less than 50 nm.

Clause 13. The composition of any one of clauses 1-11, wherein the β-casein is in a micellar form or in a monomeric form; wherein when the β-casein is in a micellar form, the β-casein has a protein a particle size of less than 500 nm.

Clause 14. The composition of any one of clauses 1-13, wherein the β-casein has a zeta potential of from about −50 mV to about −15 mV in a pH 7.0 buffer.

Clause 15. The composition of any one of clauses 1-14, wherein the protein is in a liquid form or a powder form, wherein the powder form is produced by spray drying, roller drying, drum drying, or freeze drying the protein to remove water.

Clause 16. The composition of any one of clauses 1-15, wherein the protein is a single type of native milk protein, a single type of recombinant milk protein, or a combination thereof.

Clause 17. The composition of clause 16, wherein the single type of protein is β-casein.

Clause 18. The composition of any one of clauses 1-17, wherein the protein is two or more different types of animal milk proteins, recombinant milk proteins, and plant-based proteins.

Clause 19. The composition of any one of clauses 1-18, wherein the protein is with or without post-translational modifications.

Clause 20. The composition of clause 19, wherein the post-translation modifications are one or more of glycosylation and phosphorylation.

Clause 21. The composition of any one of clauses 1-18, wherein the protein is phosphorylated.

Clause 22. The composition of any one of clauses 1-18, wherein the protein comprises non-native phosphorylation.

Clause 23. The composition of any one of clauses 6-22, wherein the recombinant caseins are produced by a fungal cell, a yeast cell, a bacterial cell, algae, or a transgenic method.

Clause 24. The composition of any one of clauses 2-23, wherein the sweetener is a nutritive sweetener, a non-nutritive sweetener, or a combination thereof.

Clause 25. The composition of clause 24, wherein the nutritive sweetener is one or more of sucrose, lactose, glucose, fructose, corn syrup solids, high-fructose corn syrup, dextrose, maltodextrin, brown sugar, honey, and maple syrup, syrups; soluble/insoluble fibers derived from corn, wheat, pea, rice, oat, coconut, barley and/or tapioca; fructo- and galacto-oligosaccharides; and hydrolysed cereal flour; or a combination thereof.

Clause 26. The composition of clause 24, wherein the non-nutritive sweetener is one or more of sucralose, aspartame, saccharin, stevia, monk fruit extract, neotame, advantame, acesulfame potassium, sugar alcohols such as maltitol, xylitol, sorbitol, erythritol, mannitol, isomalt, lactitol, hydrogenated starch hydrolysates, or a combination thereof.

Clause 27. The composition of clause 24, wherein the sweetener is one or more of brazzein, curculin, mabinlin, miraculin, monelin, pentadin, and thaumatin.

Clause 28. The composition of any one of clauses 1-27, wherein the fat comprises one or more lipids derived from a plant, an animal, one or more lipids derived from milk, or a combination thereof.

Clause 29. The composition of any one of clauses 1-28, wherein the fat comprises one or more monoglycerides, diglycerides, triglycerides, and/or phospholipids comprising a short chain fatty acid selected from the group consisting of butyric acid, caproic acid, caprylic acid, and capric acid.

Clause 30. The composition of clause 29, wherein the one or more monoglycerides, diglycerides, triglycerides, and/or phospholipids is a plant-based trans-esterified monoglyceride, diglyceride, triglyceride, and/or phospholipid comprising a short chain fatty acid selected from the group consisting of butyric acid, caproic acid, caprylic acid, and capric acid.

Clause 31. The composition of any one of clauses 1-30, wherein the fat is hydrogenated oil, interesterified oil, hydrogenated and interesterified oil, hydrogenated, blended and interesterified oil, or a combination thereof.

Clause 32. The composition of clause 29, wherein the one or more monoglycerides, diglycerides, triglycerides, and/or phospholipids comprise fatty acyl chains in a percentage that resembles a percentage of the fatty acyl chains found in a mammal-derived milk or dairy product.

Clause 33. The composition of any one of clauses 1-32, wherein the composition is whippable.

Clause 34. The composition of any one of clauses 1-32, wherein the composition is non-whippable.

Clause 35. The composition of clause 34, wherein the composition is a cooking cream or coffee creamer.

Clause 36. The composition of any one of clauses 1-35, wherein the fat is fully hydrogenated, partially hydrogenated, interesterified, non-hydrogenated, or hydrogenated and interesterified.

Clause 37. The composition of any one of clauses 1-36, wherein the fat is fully hydrogenated.

Clause 38. The composition of any one of clauses 1-37, wherein the composition further comprises a crystallizer, a flavoring agent, a salt, a preservative, or a combination thereof.

Clause 39. The composition of any one of clauses 1-38, wherein the protein is one or more of monomeric caseins, sodium caseinate, calcium caseinate, potassium caseinate, acid casein, rennet casein, micellar protein, and globular protein.

Clause 40. The composition of clause 39, wherein the globular protein is one or more of milk derived protein, plant protein, alpha-lactalbumin, beta-lactoglobulin, ovalbumin, ovoglobulin, and recombinant protein.

Clause 41. The composition of clause 39, wherein the micellar protein is micellar casein, a recombinant micellar casein, or a combination thereof.

Clause 42. The composition of clause 40, wherein the plant protein is any cereal, legume, or seed-based protein and present in an amount from about 0.05 wt. % to about 2.5 wt. %.

Clause 43. The composition of clause 41, wherein the micellar casein is sodium caseinate or calcium caseinate and is present in an amount of from about 0.05 wt. % to about 2.5 wt. %.

Clause 44. The composition of any one of clauses 2-43, wherein the stabilizer is one or more of alginate, carrageenan, guar gum, cellulose such as methyl cellulose, microcrystalline cellulose, carboxymethylcellulose, hydroxypropyl methylcellulose (HPMC), sorbitol, xanthan gum, tara gum, locust bean gum, gellan gum (such as high acyl, low acyl), beet pectin, skim milk powder, whole milk powder, partly skimmed milk powder, butter milk powder, dairy products solids, modified starch, agar-agar, gelatin, gum Arabic, konjac, pectin, maltodextrin, and tragacanth.

Clause 45. The composition of any one of clauses 2-43, wherein the emulsifier is one or more of diacetyl tartaric acid esters of mono- and/or diglycerides, lactic acid esters of mono- and/or diglycerides, sodium stearoyl lactylate, lecithin, sorbitan monostearate, polyglycol ester, propylene glycol monostearate, polysorbate, polysorbate 60, polysorbate 80, sucrose esters, sucrose monostearate, monoglyceride, beeswax, camauba wax, candelilla wax, plant waxes, fruit waxes, animal waxes, polyglycerol fatty acid esters, and polyglycerol polyricinoleate (PGPR).

Clause 46. The composition of any one of clauses 2-43, wherein the buffer salt is one or more of any sodium or potassium or calcium salts of citrate, phosphate, carbonate such as sodium polyphosphates, orthophosphate, pyrophosphate, hexametaphosphate, mono- or di-phosphate salts, mono- or di-carbonates, and halide salt.

Clause 47. A food product comprising the composition of any one of clauses 1-46.

Clause 48. The food product of clause 47, wherein the food product is a dairy product, a non-animal-derived product, a beverage product, or a combination thereof.

Clause 49. The food product of clause 47 or clause 48, wherein the food product is a coffee creamer, a cooking cream, a whipping cream, or a similar low to high fat emulsion.

Clause 50. The food product of any one of clauses 47-49, wherein the food product comprises from about 0.001 wt. % to about 3 wt. % of the protein.

Clause 51. A method of making the composition of any one of clauses 1-46, the method comprising: forming an oil phase comprising the fat; forming an aqueous phase comprising the protein; adjusting the oil phase and aqueous phase from about 15° C. to about 75° C.; mixing the oil phase and the aqueous phase to form a mixture; homogenizing the mixture to form an emulsion; heating the emulsion to about 50° C. to about 145° C.; and cooling the emulsion to about 2° C. to about 30° C.

Clause 52. The method of clause 51, wherein the method further comprises packing the emulsion in sterile or non-sterile conditions.

Clause 53. The method of clause 51 or clause 52, wherein the method further comprises storing the emulsion at from about −18° C. to about −15° C., from about 3° C. to about 5° C., or from about 18° C. to about 25° C.

Clause 54. The method of any one of clauses 51-53, wherein the aqueous phase further comprises stabilizers, emulsifiers, and buffering salts.

Clause 55. The method of any one of clauses 51-54, wherein the method further comprises aerating the emulsion or quiescently storing the emulsion.

Clause 56. The method of clause 55, wherein aerating comprises whisking, mixing using a planetary mixer, or whipping using a continuous whipping machine.

Clause 57. The method of any one of clauses 51-56, wherein the method further comprises heat treating, pasteurizing, or sterilizing the emulsion.

Clause 58. The method of clause 57, wherein the heat treating, pasteurizing, or sterilizing comprises retort, high hydrostatic pressure, ultra-violet radiation, irradiation, or ultra-high temperature processing.

Clause 59. The method of any one of clauses 51-58, wherein the emulsion has an improved storage stability compared to a corresponding emulsion.

Clause 60. A method of preparing a whipped emulsion, the method comprising whipping the emulsion of any one of clauses 51-59, wherein the whipping is performed at from about 2° C. to about 8° C.

1. An emulsion composition comprising a fat and a protein, wherein the protein comprises greater than 45 wt. % of β-casein based on the total amount of casein present in the composition;
wherein the composition comprises:
from about 5 wt. % to about 45 wt. % of the fat;
from about 0.001 wt. % to about 2.5 wt. % of the protein;
from about 0 wt. % to about 55 wt. % of a sweetener;
from about 0 wt. % to about 3 wt. % of one or more stabilizers;
from about 0.0001 wt. % to about 2 wt. % of buffer salts; and,
from about 0 wt. % to about 3 wt. % of one or more emulsifiers.

2. (canceled)

3. The composition of claim 1, wherein the composition comprises:
from about 5 wt. % to about 35 wt. % of the fat;
from about 1 wt. % to about 2.25 wt. % of the protein;
from about 5 wt. % to about 45 wt. % of a sweetener;
from about 0.5 wt. % to about 3 wt. % of one or more stabilizers;
from about 0.5 wt. % to about 2 wt. % of buffer salts; and,
from about 0.5 wt. % to about 3 wt. % of one or more emulsifiers.

4. The composition of claim 1, wherein the fat is a dairy fat, a vegetal fat, vegetal oil, algal oil, fermented oil from bacteria, yeast or mold, hydrogenated oil, hydrogenated and interesterified oil, hydrogenated, blended and interesterified oil, medium-chain triglyceride (MCT) vegetable oil, milk fat, ghee, anhydrous milk fat, butter oil, or a combination thereof.

5. The composition of claim 1, wherein the protein is an animal protein, a recombinant milk protein, a plant-based protein, or a combination thereof.

6. The composition of claim 1, wherein the protein is natural casein, recombinant casein, or a combination thereof.

7. The composition of claim 1, wherein the composition comprises a total κ-casein content of less than 0.03 wt. % based on the total composition, and wherein the composition is not used for cheese products.

8. (canceled)

9. The composition of claim 1, wherein the β-casein is natural or recombinant.

10. The composition of claim 9, wherein the β-casein is recombinant and comprises an amino acid sequence that is from about 60% to about 100% identical to an amino acid sequence of a mammalian milk protein such as a cow milk protein, a sheep milk protein, a camel milk protein, a yak milk protein, a buffalo milk protein, a horse milk protein, or a goat milk protein.

11. (canceled)

12. The composition of claim 1, wherein the β-casein is in a micellar form or in a monomeric form;
wherein when the β-casein is in a monomeric form, the β-casein has a protein particle size of less than 50 nm;
wherein when the β-casein is in a micellar form, the β-casein has a protein a particle size of less than 500 nm.

13. (canceled)

14. The composition of claim 1, wherein the β-casein has a zeta potential of from about −50 mV to about −15 mV in a pH 7.0 buffer.

15. The composition of claim 1, wherein the protein is in a liquid form or a powder form, wherein the powder form is produced by spray drying, roller drying, drum drying, or freeze drying the protein to remove water.

16. (canceled)

17. The composition of claim 5, wherein the single type of protein is β-casein.

18. (canceled)

19. The composition of claim 1, wherein the protein is with or without post-translational modifications;
wherein when the protein has post-translational modifications, the post-translation modifications are one or more of glycosylation, phosphorylation, or a combination thereof.

20-21. (canceled)

22. The composition of claim 1, wherein the protein comprises non-native phosphorylation.

23. The composition of claim 6, wherein the recombinant caseins are produced by a fungal cell, a yeast cell, a bacterial cell, algae, or a transgenic method.

24. The composition of claim 2, wherein the sweetener is a nutritive sweetener, a non-nutritive sweetener, or a combination thereof;
wherein the nutritive sweetener is one or more of sucrose, lactose, glucose, fructose, corn syrup solids, high-fructose corn syrup, dextrose, maltodextrin, brown sugar, honey, and maple syrup, syrups; soluble/insoluble fibers derived from corn, wheat, pea, rice, oat, coconut, barley and/or tapioca; fructo- and galacto-oligosaccharides; and hydrolysed cereal flour; or a combination thereof;
wherein the non-nutritive sweetener is one or more of sucralose, aspartame, saccharin, stevia, monk fruit extract, neotame, advantame, acesulfame potassium, sugar alcohols such as maltitol, xylitol, sorbitol, erythritol, mannitol, isomalt, lactitol and hydrogenated starch hydrolysates, brazzein, curculin, mabinlin, miraculin, monellin, pentadin, thaumatin, or a combination thereof.

25-27. (canceled)

28. The composition of claim 1, wherein the fat comprises one or more lipids derived from a plant, an animal, one or more lipids derived from milk, or a combination thereof;
wherein the one or more lipids comprise one or more monoglycerides, diglycerides, triglycerides, and/or phospholipids comprising a short chain fatty acid selected from the group consisting of butyric acid, caproic acid, caprylic acid, and capric acid.

29. (canceled)

30. The composition of claim 28, wherein the one or more monoglycerides, diglycerides, triglycerides, and/or phospholipids is a plant-based trans-esterified monoglyceride, diglyceride, triglyceride, and/or phospholipid comprising a short chain fatty acid selected from the group consisting of butyric acid, caproic acid, caprylic acid, and capric acid; and/or
wherein the one or more monoglycerides, diglycerides, triglycerides, and/or phospholipids comprise fatty acyl chains in a percentage that resembles a percentage of the fatty acyl chains found in a mammal-derived milk or dairy product.

31. The composition of claim 1, wherein the fat is fully hydrogenated; partially hydrogenated; interesterified; hydrogenated and interesterified; hydrogenated, blended and interesterified; non-hydrogenated; or a combination thereof.

32. (canceled)

33. The composition of claim 1, wherein the composition is whippable or non-whippable;
wherein when the composition is non-whippable the composition is a cooking cream or coffee creamer; and
wherein the composition is not used for cheese or yogurt, or cheese products or yogurt products.

34-37. (canceled)

38. The composition of claim 1, wherein the composition further comprises a crystallizer, a flavoring agent, a salt, a preservative, or a combination thereof.

39. The composition of claim 1, wherein the protein is one or more of monomeric caseins, sodium caseinate, calcium caseinate, potassium caseinate, acid casein, rennet casein, micellar protein, and globular protein;
wherein the globular protein is one or more of milk derived protein, plant protein, alpha-lactalbumin, beta-lactoglobulin, ovalbumin, ovoglobulin, and recombinant protein;
wherein the micellar protein is micellar casein, a recombinant micellar casein, or a combination thereof.

40-41. (canceled)

42. The composition of claim 39, wherein the plant protein is any cereal, legume, or seed-based protein and present in an amount from about 0.05 wt. % to about 2.5 wt. %.

43. The composition of claim 39, wherein the micellar casein is sodium caseinate or calcium caseinate and is present in an amount of from about 0.05 wt. % to about 2.5 wt. %.

44. The composition of claim 1, wherein the stabilizer is one or more of alginate, carrageenan, guar gum, cellulose such as methyl cellulose, microcrystalline cellulose, carboxymethylcellulose, hydroxypropyl methylcellulose (HPMC), sorbitol, xanthan gum, tara gum, locust bean gum, gellan gum (such as high acyl, low acyl), beet pectin, skim milk powder, whole milk powder, partly skimmed milk powder, butter milk powder, dairy products solids, modified starch, agar-agar, gelatin, gum Arabic, konjac, pectin, maltodextrin, and tragacanth;
wherein the emulsifier is one or more of diacetyl tartaric acid esters of mono- and/or diglycerides, lactic acid esters of mono- and/or diglycerides, sodium stearoyl lactylate, lecithin, sorbitan monostearate, polyglycol ester, propylene glycol monostearate, polysorbate, polysorbate 60, polysorbate 80, sucrose esters, sucrose monostearate, monoglyceride, beeswax, camauba wax, candelilla wax, plant waxes, fruit waxes, animal waxes, polyglycerol fatty acid esters, and polyglycerol polyricinoleate (PGPR);
wherein the buffer salt is one or more of any sodium or potassium or calcium salts of citrate, phosphate, carbonate such as sodium polyphosphates, orthophosphate, pyrophosphate, hexametaphosphate, mono- or di-phosphate salts, mono- or di-carbonates, and halide salt.

45-46. (canceled)

47. A food product comprising the composition of claim 1.

48. The food product of claim 47, wherein the food product is a dairy product, a non-animal-derived product, a beverage product, or a combination thereof; and
wherein the food product is not cheese, yogurt, a cheese product, or a yogurt product.

49. The food product of claim 47, wherein the food product is a coffee creamer, a cooking cream, a whipping cream, or a similar low to high fat emulsion.

50. The food product of claim 47, wherein the food product comprises from about 0.001 wt. % to about 3 wt. % of the protein.

51. A method of making the composition of claim 1, the method comprising:
forming an oil phase comprising the fat;
forming an aqueous phase comprising the protein;
adjusting the oil phase and aqueous phase from about 15° C. to about 75° C.;
mixing the oil phase and the aqueous phase to form a mixture;
homogenizing the mixture to form an emulsion;
heating the emulsion to about 50° C. to about 145° C.; and
cooling the emulsion to about 2° C. to about 30° C.

52. The method of claim 51, wherein the method further comprises:
packing the emulsion in sterile or non-sterile conditions;
storing the emulsion at from about −18° C. to about −15° C., from about 3° C. to about 5° C., or from about 18° C. to about 25° C.;
aerating the emulsion or quiescently storing the emulsion, wherein aerating comprises whisking, mixing using a planetary mixer, or whipping using a continuous whipping machine; and/or
heat treating, pasteurizing, or sterilizing the emulsion, wherein the heat treating, pasteurizing, or sterilizing comprises retort, high hydrostatic pressure, ultra-violet radiation, irradiation, or ultra-high temperature processing.

53-58. (canceled)

59. The method of claim 51, wherein the emulsion has an improved storage stability compared to a corresponding emulsion.

60. A method of preparing a whipped emulsion, the method comprising whipping the emulsion of claim 51, wherein the whipping is performed at from about 2° C. to about 8° C.
